(19) United States
(12) Patent Application Publication
(10) Pub. No.: US 2026/0153638 A1
(43) Pub. Date: Jun. 4, 2026

(54) System and Method for Seismic Geophysical Characterization and Imaging Using Permanent Compact Volumetric Arrays

(71) Applicant: Quantum Technology Sciences, Inc., Cocoa Beach, FL (US)

(72) Inventors: Derek QUIGLEY, Satellite Beach, FL (US); Paul A NYFFENEGGER, Rockledge, FL (US); Michael S ANTOLIK, Melbourne, FL (US); Kevin D HUTCHENSON, Melbourne, FL (US); Elige B GRANT, Houston, TX (US)

(73) Assignee: Quantum Technology Sciences, Inc, Cocoa Beach, FL (US)

(21) Appl. No.: 19/402,233

(22) Filed: Nov. 26, 2025

Related U.S. Application Data
(60) Provisional application No. 63/726,469, filed on Nov. 29, 2024.

(51) Int. Cl. G01V 1/34; G01V 1/30

(52) U.S. Cl. CPC G01V 1/345; G01V 1/301; G01V 1/308

(57) ABSTRACT

A system includes an active seismic source, a compact volumetric phased array, and a processing system. The active seismic source is configured to provide controlled seismic energy. The compact volumetric phased array is configured to detect seismic signals generated responsive to the controlled seismic energy. The processing system is coupled to the compact volumetric phased array. The processing system is configured to: generate, at a first time, a first image representative of a geologic structure based on the seismic signals produced by a first activation of the active seismic source; generate, at a second time, a second image representative of the geologic structure based on the seismic signals produced by a second activation of the active seismic source; and responsive to generation of the first and second images, automatically determine a difference between the first image and the second image; and provide a change-in-state notification based on the difference.

### CROSS-REFERENCE TO RELATED APPLICATIONS

This application claims priority to U.S. Provisional Application No. 63/726,469 filed Nov. 29, 2024, entitled “System and Method for Seismic Geophysical Characterization and Imaging Using Permanent Compact Volumetric Arrays,” which is hereby incorporated by reference. This application is also related to U.S. Pat. No. 12,117,576 which is hereby incorporated by reference.

### FIELD OF INVENTION

Embodiments of the invention relate to systems and methods of processing seismic reflection survey data consisting of continuously sampled time series acquired using geophones, hydrophones, accelerometers, and similar sensors that produce a response proportional to ground particle motion or strain and that are deployed and arranged as a permanently emplaced compact volumetric phased array as described herein and in referenced U.S. Pat. No. 12,117,576, in order to reduce the repeated active-source survey processing to an automated sequence, and automatically generate monitoring information useful to the facility operators.

### BACKGROUND

It is desirable to detect, characterize, and understand subsurface geologic structure and properties without having to directly sample the subsurface geology. It is also desired to detect changes of state in monitored geologic volumes or strata, which are being monitored because of utility in resource production, including geothermal production, or waste disposal. The high interest geologic structures within the volumes are commonly called reservoirs and represent subsurface assets to commercial and government entities and landowners. Changes of state may include geophysically measured material parameters such as velocity, reflectivity (or impedance), and density of the underground assets, and may also include derived geologic parameters and the geophysical state of stress.

The seismic reflection method is a well-established technique in mineral exploration to map subsurface geology. Of particular interest are geologic structures important for resource extraction, resource storage, and waste storage and disposal. Seismic exploration surveys using multiple independent sensors, also called receivers (generalized to “geophones”) and deployed as a “carpet” or dense two-dimensional arrangement of various patterns, together with one or more controlled active sources, used at multiple source locations, is a common approach of the seismic reflection method for imaging subsurface geologic structures. Many different methodologies exist in the literature for the placement of active controlled seismic sources and receivers. Generally, the design goal of these methods seeks an optimally efficient sampling of the three dimensional geologic volume while maximizing diversity in source-receiver offset and reflection angle but still using sources and receivers primarily in the plane of the surface and in a temporary emplacement. Science and engineering disciplines that use the information gained from active source seismic survey techniques span the fields of geology and geophysics, archeology, environmental, urban, ocean, geotechnical, civil, mine, and petroleum engineering, and their sub-disciplines. Information obtained this way includes the structure of the three-dimensional geologic volume and the physical character and attributes of that structure, to include resource reservoirs and caprocks or confinement structures, and changes in the geologic structure or attributes due to engineering activities.

Passive seismic methods using either ambient noise or microseismic events are used for similar but limited imaging purposes. Passive microseismic monitoring applications include but are not limited to hydraulic fracturing and similar unconventional petroleum production activities, monitoring microseismic events associated with underground petroleum storage facilities and reservoirs and unconventional reservoirs, underground mining and solution mining, geothermal and enhanced geothermal energy production, underground liquid disposal and analogous operations, and carbon capture and storage operations. The longer-term aspects of some of these applications require permanently emplaced geophones to develop an accurate understanding of the evolving state of the geological asset and the effect of engineering activities, whether gases, fluids, or mixtures are being introduced or extracted. These passive networks are generally required for monitoring a geologic volume to obtain information over long periods of time from these uncontrolled seismic events about the individual events, the spatial and time relationship of these events to geological structures, and the state of the underground assets. Permanently emplaced passive compact volumetric phased arrays provide monitoring improvements compared to temporarily placed “carpet” networks of surface sensors.

### SUMMARY

In one example, a system includes an active seismic source, a compact volumetric phased array, and a processing system. The active seismic source is configured to provide controlled seismic energy. The compact volumetric phased array is configured to detect seismic signals generated responsive to the controlled seismic energy. The processing system is coupled to the compact volumetric phased array. The processing system is configured to: generate, at a first time, a first image representative of a geologic structure based on the seismic signals produced by a first activation of the active seismic source; generate, at a second time, a second image representative of the geologic structure based on the seismic signals produced by a second activation of the active seismic source; and responsive to generation of the first and second images, automatically determine a difference between the first image and the second image; and provide a change-in-state notification based on the difference.

In another example, a method includes acquiring first seismic signals using one or more compact volumetric phased arrays, and providing the first seismic signals to a processing system, and processing, by the processing system, the first seismic signals to produce a first image representative of a geologic structure. The method also includes acquiring second seismic signals using the one or more compact volumetric phased arrays, and providing the second seismic signals to the processing system, and processing, by the processing system, the second seismic signals to produce a second image representative of the geologic structure. The method further includes automatically generating time-lapse change-in-state information representing a difference between the first image and the second image, and automatically providing a change-in-state notification indicating a need for corrective action directed to the geologic structure.

In a further example, a seismic system includes a active seismic source, a compact volumetric phased array, and a data acquisition system. The active seismic source is configured to provide controlled seismic energy. The compact volumetric phased array is configured to detect seismic signals generated responsive to the controlled seismic energy. The data acquisition system is coupled to the active seismic source and the compact volumetric phased array. The data acquisition system is configured to record the seismic signals detected by the compact volumetric array.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an example seismic data acquisition plan for a wide area 3D characterization of a geologic volume.

FIG. 2 is a schematic diagram of an example seismic data acquisition and processing system that monitors and controls use of a geologic volume.

FIGS. 3A and 3B are graphs of example array response patterns displaying array directivity for a volumetric array.

FIG. 4 is a graph showing an example volumetric phased array represented in a spherical coordinate system.

FIGS. 5A and 5B show examples of specular reflection, and scattering and diffraction, respectively.

FIG. 6 is a schematic of an example source-receiver arrangement showing specular reflection points.

FIG. 7 is a schematic source-receiver arrangement for a two-dimensional seismic survey showing specular reflections occurring at marked midpoints.

FIG. 8 illustrates examples of specular reflection compared to scattering and diffraction.

FIG. 9 is a stacking diagram showing receiver and common midpoint positions as a function of common shot positions.

FIG. 10 shows example beam main response axes (MRAs) in an Earth volume containing a seismic source, a compact volumetric phased array, and a specular reflection path.

FIG. 11 is a block diagram of an example of the Seismic Survey Processing System of FIG. 2.

FIG. 12 is a block diagram of an example of the Seismic Survey Processing System of FIG. 2 configured for permanent active source acquisition.

FIG. 13 is a flowchart of an example method of generating a volumetric phased array supergather from a standard two dimensional survey line.

FIG. 14 is a flowchart of an example method of targeted beamforming for producing an enhanced receiver gather using seismic survey data provided by a compact volumetric phased array.

FIG. 15 is a flowchart of an example method of targeted beamforming for producing an enhanced receiver gather including a composite beam.

FIG. 16 is a flowchart of an example method of targeted beamforming for producing an enhanced receiver gather comprised of dynamically steered beams.

FIG. 17 shows an example two-dimensional vertical slice through an Earth volume with beam main response axes aligned with expected paths of diffracted energy.

FIG. 18 is a block diagram of a computing system suitable for implementing a Seismic Survey Processing System as shown in FIG. 2.

### DETAILED DESCRIPTION

The same permanent compact volumetric phased arrays used for passive monitoring may be used for active source imaging. Here, the goal is not to provide a wide three dimensional image of the subsurface but a more limited sampling using a spatially sparse network for subsurface sampling. The overall benefit is in generating a highly repeatable image and characterization of a limited volume at a reduced cost because of the reduced footprint of the permanent array acquisition. Moreover, this repeatable imaging is amenable to automated processing and time-lapse analysis to provide the sought geophysical state information.

In the present disclosure, some embodiments of the invention are specified as a method comprising a series of processing steps implemented as computer instructions, installed on stand-alone or specialized computational platforms, that enable a processing of the input signals data supplied by a permanent compact volumetric phased array, for the generation of subsurface image or characterization information that is superior to existing methods, and then to compare previous images or characterizations in an automated fashion to produce time lapse information indicative of a change in state of the subsurface assets, and then to generate a notification upon attainment of certain conditions and measures of confidence. The notification is used in resource production or waste disposal operations management systems to limit and reduce risks to the geologic assets and negative implications for the overlying geologic structure and surface infrastructure.

The geologic asset is a porous reservoir or volume containing resources, or capable of containing a volume of injected product or waste by-products (referred to as injected products herein), and includes non-porous or impermeable caprock geologic horizons or other geologic structures that prevent the resources or injected products from movement out of the geologic asset.

Signal data acquired by the compact volumetric phased arrays originate with standard seismic sources used in exploration geophysics to generate signals of such magnitude that the generated elastic waves travel down through geologic strata, interact with and become reflected by geologic boundaries and structures within the Earth, and then travel to the point of data acquisition at the emplaced compact volumetric phased arrays. Examples of such sources include large vibrational units that generate frequency-controlled signals, accelerated impact or weight drop units that generate broadband impulsive transient signals, air guns and explosive charge sources that generate broadband impulsive transient signals, and a variety of other units that generate frequency controlled or impulsive signals. Furthermore, an additional class of permanently installed controlled sources (also referred to as a permanently emplaced seismic source) exists taking advantage of frequency controlled or broadband impulsive seismic signal generation that provides an automated seismic source functionality not requiring operators of the source in the field, but in a fixed, limited geometry.

The data acquired using the compact volumetric phased arrays in conjunction with the controlled active seismic sources are then processed using coherent phased array methods, one of which is beamforming, to form multiple beams of signal data along specific angles of arrival using directly measured phase velocities, together defining the beam's main response axis or MRA. The method may then direct that the beams are processed to highlight, separate, or isolate specific desired vector ray paths and associated signal data to further characterize the subsurface. According to the method, the subsurface geological structures can be primarily characterized using a gather of one or more suites of targeted beams' time series collected from multiple controlled source shot points forming an image representative of geologic structure and properties. Information can be extracted from the beamformed time series for specific geologic properties of specific geologic volumes. Targeted beams, as used in this context, refers both the beam geometry specified using the MRA and the phase velocity, as well as the target depth point which also takes into account the ray path from the subsurface geologic structure under interrogation to the compact volumetric phased array. For the permanent source-permanent array processing, information is extracted from the single beam time series in the form of waveform features, in time domain, frequency domain, and similar data transforms, projections and joint-domain projections. This embodiment has an advantage of being able to be completely automated, controlled from a remote location, and generating change-in-state assessment in near-real time. Embodiments of the invention detail basic and advanced methods to beamform the data provided by the volumetric phased arrays using active seismic sources and derive geological and/or geophysical attributes and images of the subsurface from that beamformed data.

Once the processing sequence is determined and a baseline image generated, or the baseline features generated (for the permanent source variant), the sequence is automated to generate images and extract features based on the same source-receiver acquisition geometry. A time-lapse comparison then may be generated by differencing the images and feature sets, and the difference image operated on to identify changes of state in specified zones using pattern analysis methods. At least one pattern analysis method includes an artificial intelligence component once sufficient training data have been accumulated.

Any recognized changes of state become notifiable events, and the system then proceeds to automatically issue the notification. The automated notification is issued to field operator personnel and any control systems of hardware components (e.g., an external operations management system or automated control system) for production or waste disposal systems such as pressure controls, fluid injection systems featuring pumps, downhole lift systems featuring downhole pumps, automated valve systems at the well head or in the injection control systems. When the notification is received, the control systems may be configured to limit or reduce flow, reduce pressures or similar actions based on the provided information to reduce risk to the geologic assets and infrastructure.

In all cases discussed herein using seismic methods, sensors are emplaced in a fully elastic medium or at a surface between a fully elastic and an acoustic medium as opposed to entirely within an acoustic medium. The received propagating seismic waves thus consist of multiple signals from the same source acting at a single point in time: superimposed compressional waves, shear waves, and Rayleigh waves (or Scholte waves in underwater applications), arriving at the array elements nearly simultaneously. Because different types of seismic waves travel at different velocities, it is possible to take advantage of the phase velocities. For example, compressional waves travel faster than shear waves, and shear waves travel faster than surface (Rayleigh) waves. The processes that advantageously use differences in arrival times and propagation velocities are not always successful when applied to single-sensor data. Processing methods that take advantage of differences in arrival times and propagation velocities applied to data from volumetric phased arrays with elements providing independently acquired digital channels inherently relieves much of the difficulty compared to similar methods applied to single sensor data.

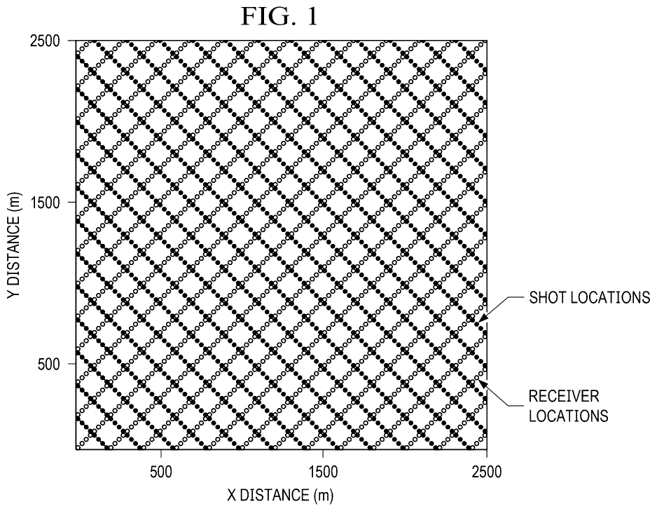

The state-of-the-art in active source seismic reflection survey technologies developed for underground exploration and reservoir monitoring typically involve network “carpets” of many geophone channels and source locations (called shot points) with geometries specified for generating high-fold data over a broad range of offsets and azimuths for a full three-dimensional characterization of the subsurface geology. FIG. 1 is a schematic diagram of an example seismic data acquisition plan showing shot points and receiver locations. The plan of FIG. 1 illustrates a planar orthogonal acquisition layout (in map view) planned for reflection imaging a three-dimensional volume with a bottom depth of 2 km.

A wide variety of digital data processing methods designed for imaging and understanding the subsurface from seismic reflection data have been developed. These methods are published in books and journals associated with these active source imaging technologies, all focused on determining the geologic structure of the media through which seismic waves propagate.

In traditional seismic surveys, developing two- and three-dimensional characterizations and images of the geologic structure requires a large number of independent geophones deployed as an intentional and planned network of seismic data acquisition instruments distributed over a wide area usually at or near the Earth's surface in a linear or two-dimensional (planar) deployment to provide redundant shallow specular reflection and long-offset diffraction source-receiver geometries as well as deep reflection source-receiver geometries (e.g., FIG. 1). These receiver locations are generally temporary sensor deployments, and often times sensors are moved among planned locations during a survey campaign. A large number of source “shot points” likewise distributed over a wide area is also required to optimize imaging results using the large number and areal distribution of geophones.

However, using fixed source units and permanent arrays is an alternate configuration for providing interrogation of a small geologic volume and information on the geophysical state of that volume. In such cases, a pedestal-mounted permanent source that is automated for remote operation is used in conjunction with the permanent compact volumetric phased array receiver system. As an example, the pedestal is a metal-bore pipe stem drilled into the ground, also called a screw-pile, about 20-25 meters with a source then attached at the surface. The pipe stem passes through the alluvial and weathered layer and is emplaced with the bottom most portion or toe into a non-weathered stratum. The controlled source is attached at the top of the pedestal near ground level, but transferring the energy to exit from the bottom of the pipe stem, thus avoiding propagation through the upper weathered layers. The source may be impulsive (broadband), or a frequency controlled unit. The permanent source-permanent receiver array configuration has the advantage of complete remote operation and producing the desired change-in-state information automatically in near real time without operator or analyst intervention.

Planning the deployment and placement of the individual geophones and shot points for active source seismic surveys is an exercise in trade-offs and optimization. Important factors to be balanced include economic considerations of costs and time, the number of available geophones, any known depth and lateral scale of the desired structures to be characterized, and the seismic fold required to image those structures under normal noise conditions. The result of the planning exercise is a set of field parameters for deploying the suite of geophones defining, for example, maximum source-receiver offsets (comparable to the depth of the geology of interest), minimum offset (no greater than the shallowest geology of interest), maximum deployed geophone group length (minimum apparent velocity of the reflections), minimum in-line geophone spacing within groups (determined from surface noise), and geophone group interval (less than twice the horizontal resolution). Defining the spacing of these geophones does not usually include consideration of the near surface elastic wave velocities and wavelengths within the frequency bands of interest.

Deploying passive phased arrays of seismometers and geophones arranged in a line or in two-dimensional distributions and beamforming the data provided by such phased arrays is a common approach used for locating and characterizing unknown and uncontrolled seismic sources such as earthquakes or nuclear explosion tests since the late 1950s. Designing these phased arrays always includes consideration of the geophysical properties where the geophones are placed for determining the wavelengths of the desired signals at the point of measurement, and for determining the ideal spacings of the geophones to ensure collection across the band of interest, but does not consider the depths to the geologic zones of interest or other field parameters listed above.

Attempting to determine geologic structures pertinent in resource production and waste disposal with passive methodologies alone (without an active source) requires deploying nearly the same number of sensors over the same areal extent as with active source surveys but, moreover, collecting data over extended time periods, e.g., months to years. With no guarantee that the desired structures will be uniformly imaged there is no generally applicable advantage to a purely passive seismic approach for imaging reservoir geologic structures.

Systems and methods described herein use the same passive compact volumetric phased arrays that supply persistent passive microseismic monitoring for acquiring active-source seismic survey signals, and process and exploit those signals for imaging and characterizing a geologic reservoir or asset, using approaches that are applicable to data collected by the volumetric arrays but not usually enabled by other survey geometries. The dual use provided by the compact volumetric phased arrays offers a cost savings and a superior imaging capability but over a limited survey geographical extent.

Obtaining useful images and characterization information about geologic assets requires consideration of numerous factors such as compressional and shear wave propagation velocities and velocity structure, anisotropic propagation, multiple propagation modes and paths of reflection, refraction, and diffraction. Given that propagation through such media is complex, features of the disclosed embodiments include methods of manipulating the acquired data to identify and isolate the desired seismic waveform arrivals within the data provided by the volumetric arrays and derive characterization or image information from the processed data to the benefit of understanding the state of geophysical conditions in the underground assets.

Once the sequence is determined and a baseline image generated, the processing sequence is automated to generate images based on the same source acquisition geometry. Regular active source surveys are executed at time intervals, and the data used to develop time-lapse analysis of the response of the underground assets to the engineered production and disposal activities, yielding time-lapse information. For the permanent source pedestal mounted systems, signals acquired by the compact volumetric phased arrays from individual, repeated permanent source shots are conditioned for quality and frequency content to edit out bad shots consisting of weak shots, misfired shots, or shots with timing errors, and then the final conditioned set are averaged, or “stacked” in the language of the art, based on shot times to enhance the signal-to-noise ratio (SNR). Once the baseline feature set is determined, this analysis is also automated to produce information accompanying the waveform.

The subsurface image, waveform, or characterization information is then compared to previous images or characterizations in a time-lapse evaluation by differencing the images to produce information indicative of a change in state of the subsurface, then specified high interest zones operated on using pattern analysis methods to ascertain a change-in-state. Using signals originating with the permanent source for example, changes-in-state indicators extracted from the waveform and features relevant to the geologic volume about the reflection point in comparison to the base values are monitored at short intervals, for example routine source firing on a daily, weekly, or monthly schedule. Thus, with the approach using permanent sources, the data acquisition function may be completely automated such that the analysis of the acquired data through the time-lapse analysis using the volumetric phased array may also be performed automatically. Therefore, the entire process required to generate time-lapse information, the change-in-state assessment, and change-in-state information may be performed without operator or analyst intervention. Furthermore, because the entire sequence of source action, data acquisition, and processing and analysis may be completely automated, the change-in-state assessment may be performed in near-real time.

The result of aforementioned comparison is automatically logged in an auditable system record. When a change-in-state is indicated, and upon attainment of certain conditions and measures of confidence, a flag is set for a notifiable event, and the system then proceeds to automatically issue the notification. The automated notification contains all necessary characterization information and may include data or image snippets or results and measures of confidence. The automated notification is issued to field operator personnel and automatically forwarded to any control systems of hardware components used in the field operations.

Modern field production or waste disposal operations rely on supervisory control and data acquisition systems (SCADA) and distributed control systems (DCS), or similar automated or semi-automated systems for monitoring and controlling industrial scale processes of equipment that must be coordinated. For field operations that may result in induced seismicity, “adaptive traffic light systems (ATLS)” have been instituted for managing operations and managing and mitigating risks via decision control frameworks. See, e.g., Wildenborg et al., Transferring responsibility of CO2 storage sites to the competent authority following site closure, Energy Procedia (2014). The goal of traffic light systems is to provide a condition-based procedure for dealing with measured-data anomalies compared to expectations, model predictions, and regulation allowances. Traffic light systems consist of a decision workflow based on an understanding of technical risks that determines the existing overall state of operations at any particular facility. Thus, ATLS protocols must be custom designed individually for each facility.

The facility equipment control systems will include the ability to input information provided by one or more monitoring systems, and then potentially react to that received information to effect a change in operations following established traffic light protocols or similar reactive protocol systems. Nominally, the operational change is based on understandings of risk derived from the measurements or analysis results, and constitutes instructions to maintain or reduce volumes or pressures using mechanical control systems. The instructions may be computer instructions to the mechanical control systems directly communicated from computer to computer or may be recommendations to operators that require operator affirmation to enact a set of computer instructions to the mechanical control systems.

Where integrated SCADA and DCS control systems do not exist, individual controls may be added for each individual remotely operated production or disposal subsystem. In either case, the notification provided by the seismic monitoring system provides condition-based monitoring information such that pressure controls, fluid injection systems featuring pumps, downhole lift systems featuring downhole pumps, automated valve systems at the well head or in the injection control systems are then adjusted to limit or reduce flow, reduce pressures, shut down or related actions that reduce or mitigate risk to the geologic assets and infrastructure.

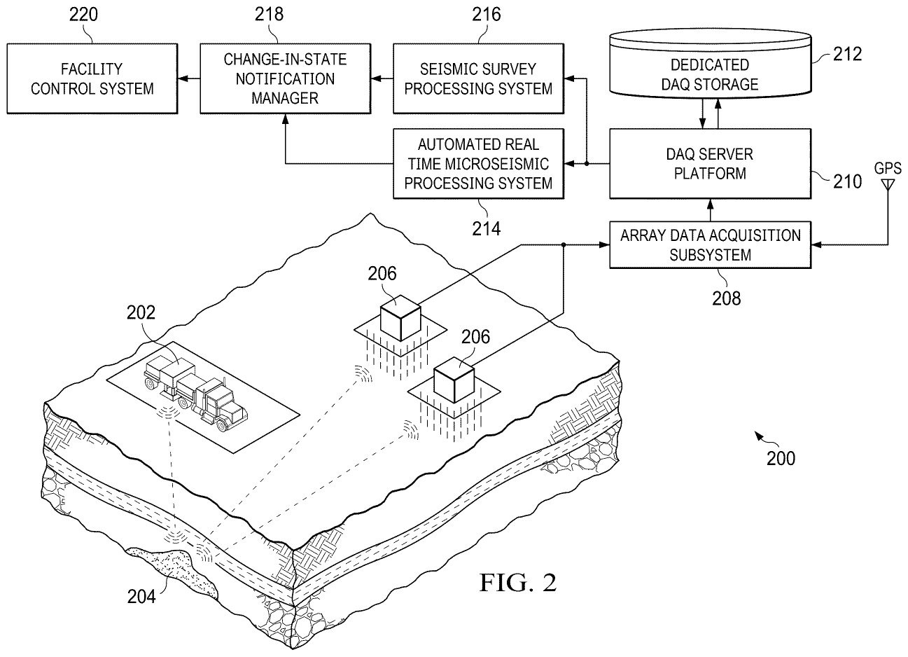

Such reactive risk management and mitigation systems are also used with passive microseismic monitoring data acquisition and analysis systems like those described in U.S. Pat. No. 12,117,576 and Braun et al (2024). See, e.g., Braun et al., Review of existing Traffic Light Systems and their potential for application to CO2 storage. EnsureCO2 report D2.3, (November 2024). Moreover, for some applications, it is a legal requirement to prove conformance (or conformity) between geologic asset models (e.g., reservoir models) and monitoring observations. Conformance is generally measured using active source seismic surveys. FIG. 2 is a schematic diagram of an example seismic data acquisition and processing system 200 that monitors and controls use of a geologic volume. FIG. 2 is an overall drawing of the seismic data acquisition and processing system 200, including its interfaces with adjacent systems. The system elements are described below. The seismic data acquisition and processing system 200 includes a seismic source 202 (an active seismic source that generates controlled seismic energy), such as a vibrational seismic source, a geologic reservoir asset 204, one or more compact volumetric phased arrays 206 (e.g., a single compact volumetric phased array or multiple compact volumetric phased arrays), and a data acquisition subsystem 208. The data acquisition subsystem 208 is coupled to the compact volumetric phased arrays 206 and the seismic source 202 by any of a variety of communication media, including electrical, optical, or wireless communication media. The data acquisition subsystem 208 receives seismic data from the compact volumetric phased arrays 206, and provides the received seismic data to the data acquisition (DAQ) server 210. The DAQ server 210 may store the seismic data in DAQ storage 212, and provide the seismic data to processing systems, such as the Automated Real Time Microseismic Processing System 214 and the Seismic Survey Processing System 216.

The Automated Real Time Microseismic Processing System 214 and the Seismic Survey Processing System 216 are coupled to the DAQ server 210 for receipt of seismic data received from the compact volumetric phased arrays 206. The Seismic Survey Processing System 216 may be located proximate the compact volumetric phased arrays 206, or located at a site remote from the compact volumetric phased arrays 206. In the seismic data acquisition and processing system 200, the compact volumetric phased arrays 206 act as the basic data source for both the Automated Real Time Microseismic Processing System 214 which encompasses passive seismic monitoring functionality, and the Seismic Survey Processing System 216 which encompasses semi-automated or automated active source seismic survey analysis functionality. The compact volumetric phased arrays 206 detects seismic signals and provides the detected seismic signals to the processing systems. The results of both processing systems provide measurements, derived measurements, and derived information of notifiable changes-in-state of the underground assets.

All changes-in-state that reach or surpass basic thresholds for confidence are managed in the Change-in-state Notification Manager (Notification Manager) 218. The Notification Manager 218 coordinates and packages available information provided from the Seismic Survey Processing System 216 as a computer-to-computer communication of actionable information, to be used within the facility SCADA or DCS control system 220. The facility control system 220 may be an internal or external operations management system with established Adaptive Traffic Light System or similar protocol to effect changes in the facility key industrial subsystems. The information may also be available through the overall system user interface (not illustrated).

Components and subsystems of the seismic data acquisition and processing system 200, including the data acquisition subsystem 208, the DAQ server 210, the DAQ storage 212, the Automated Real Time Microseismic Processing System 214, the Seismic Survey Processing System 216, the Notification Manager 218, and the facility control system 220 may be communicatively coupled by a variety of communication media. For example, local area networks, wide area networks, the INTERNET, etc. may be used to communicatively couple the data acquisition subsystem 208, the DAQ server 210, the DAQ storage 212, the Automated Real Time Microseismic Processing System 214, the Seismic Survey Processing System 216, the Notification Manager 218, and the facility control system 220 using wired, wireless, or optical communication media.

### Definitions

As used herein, the term “seismic” refers to signals in the form of elastic waves transmitted through solid or fluid Earth media in the form of seismic or acoustic waves in frequency ranges extending from below 1 Hertz (Hz) up to at least 2 kilohertz (kHz).

As used herein, the expression “sensor array” refers to a phased array, a coordinated spatially distributed arrangement of array elements, e.g., point-sensors that may be used to process the individually provided channels of data using cooperative mathematical operations that combine all the data channels to produce one or more derived data channels.

“Point-sensor,” in the context of the wavelengths of a sensed wavefield, means a sensor that measures the applicable field at a single point in three-dimensional space, rather than as a distributed sensor that measures the field over a finite aperture compared to the wavelength of the measured signals. Specifically, the dimensions of the point-sensor are much smaller than the wavelength of the maximum seismic frequency of interest.

“Geophone” as used herein is a general point sensor receiver (a transducer) used to sense elastic waveforms propagation in Earth media, having a response that is proportional to the amplitude of seismic waves or their time derivatives, and thus may take advantage of electromechanical, electric, piezoelectric, or optical construction and phenomenologies, and described geophones have a response proportional to displacement, particle velocity, acceleration, strain, or strain rate.

“Multicomponent,” sometimes also called “tri-axial” refers to a single package of multiple geophones (in the general sense) having a directional sensitivity response pattern, geometrically arranged in such a manner that the produced channels of data can be reduced to three channels representing orthogonal sensing directions.

“Compact array” refers to a convex polytope arrangement of phased array elements having apertures defined, for example, in horizontal and vertical planes such that the aperture in the respective planes is limited to that determined by the array design frequency that maximizes dimensions of the convex hull containing all sensors in that plane and where all vertices are array elements.

“Volumetric array” refers to a three-dimensional array geometry, where the individual array elements are arranged in a three-dimensional distribution that encloses a polyhedral volume of earth. The volumetric array elements are arranged with inter-element spacings corresponding to one or more design frequencies and may be arranged in any of multiple ways to enclose a volume so long as all sensors are either located at vertices or interior to the boundaries of the polyhedron.

“Array Element” means an arrangement of one or more sensors at a single point within a sensor array.

“Coherence length” is the propagation distance over which a signal wave maintains a specified degree of coherence. The coherence length is frequency dependent and, to some extent, site dependent. For described embodiments, the array aperture is not much greater than the seismic wave coherence length in order for the beamforming operation to yield a gain.

“Array aperture” is a general term referring to the maximum distance across the array. “Specific aperture” as used herein is the maximum aperture contained in the plane perpendicular to the angle of arrival or ray parameter of a plane wave. Unless the array geometry is in the form of a regular sphere, array aperture is a function of both azimuth (measured clockwise from north in the horizontal plane) and depression angle sometimes also called dip (measured down from the horizontal plane). As is well-known, the array aperture determines the ability to resolve the angle of arrival of an incoming signal.

“Array aspect ratio” is the ratio of an array geometry's smallest dimension to its largest dimension.

“Seismic Fold” is the multiplicity or redundancy of seismic wave sampling of mid-point bins, assuming specular reflections at multiple depths corresponding to the source-receiver mid-point bin, using the variety of source-receiver offsets and azimuths coinciding in that bin.

“Spatial coherence processing” means operations that use the multiple channels of data acquired with multiple suitably arranged point-sensors (e.g., in a phased array of spatially distributed sensors) to derive series or measures especially useful in characterizing and understanding signals acquired by the array within the signal's and phased arrays' coherent limitations. A common type of spatial coherence processing is beamforming, where signals, acquired with a phased array, are processed based on signal coherence across the multiple spatially distributed point-sensors that result in maximizing the signal-to-noise-ratio of the received signal, providing an estimate of the angle of arrival of the signal, and providing a measurement of the phase velocity of the signal.

“Time lapse” is the term for determining changes in state of a geological volume by repeatedly measuring that volume and determining changes by differencing in monitoring measures. The most obvious measures are the two dimensional vertical structural images generated using the aforementioned permanent arrays in conjunction with a moveable seismic source, and the single trace collapsed or compressed measurement obtained from using the aforementioned arrays in conjunction with one or more permanently emplaced sources.

“Transverse” or “crossline,” “Radial” or “inline,” and “Sagittal” or “vertical,” all refer to directional components in a multi-component seismic acquisition node that may be either physical orientations of orthogonal components, or vibrational polarizations of received signals.

### Compact Volumetric Phased Array

This section introduces Compact Volumetric Phased Arrays of seismic sensors because the methods described herein have application to seismic measurement data supplied by that specific class of phased arrays. Embodiments of computer implemented data processing methods according to the invention exploit signal data collected by compact volumetric phased arrays such as those defined in the related patents. The term volumetric as used herein refers to a three-dimensional array geometry, where the individual array point-sensors (known generally as array elements) are arranged in a three-dimensional distribution that encloses a polyhedral volume of earth, as opposed to the traditional large area planar, two-dimensional arrays used for passive monitoring of earthquakes and explosions, and the two-dimensional areal deployments of independent sensors used traditionally in active-source seismic surveys for exploration and characterization of a two- or three-dimensional Earth volume.

The term compact volumetric array as used herein refers to a convex polytope arrangement of array elements having apertures defined, for example, in horizontal and vertical planes such that the aperture in the respective planes is limited to that determined by the array design frequency that maximizes dimensions of the convex hull containing all sensors in that plane and where all vertices are array elements with spacing between elements d determined for at least one design frequency.

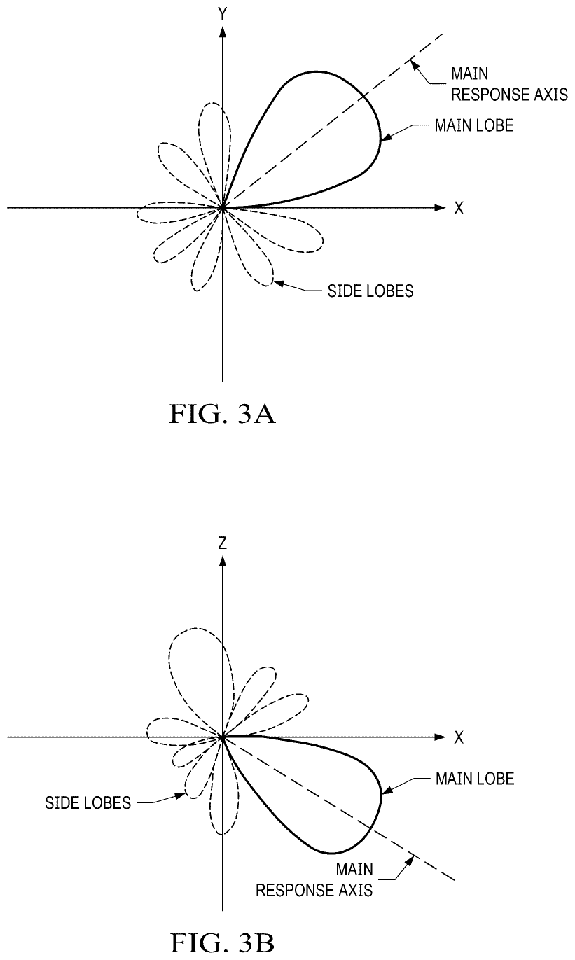

A range of exemplary compact volumetric phased array designs can be found in U.S. Pat. No. 12,117,576. A class of coherent signal processing operations applied to data measured using phased arrays is largely designated as “beamforming.” The results of beamforming include enhanced signal-to-noise ratio for signals arriving in preferred orientation of the beam, called the beam main response axis or MRA, and spatial filtering of noise and interfering signals arriving from other directions, as usually portrayed using an array response pattern. FIGS. 3A and 3B are graphs of example array response patterns displaying array directivity for a volumetric array, with beam main response axis (MRA) specified as azimuth, depression angle, and phase velocity. FIG. 3A illustrates an azimuthal cut, i.e., directivity response pattern in the horizontal plane through the array centroid, assuming a MRA close to the horizontal plane, and FIG. 3B illustrates an elevation cut i.e., directivity response pattern in the vertical plane containing the x axis, assuming a MRA close to the x-z plane. The description of beamforming in the context of this application is provided in later sections.

Because the array is designed to measure propagating seismic waves and the sensors for doing so are geophones or accelerometers with a directional response, it is common to have array elements occupied by three directional sensors oriented orthogonally to capture all particle motion, generally called three-component stations, or 3C stations. In other words, the method described herein is designed to implicitly allow for an array element taking the form of a tri-axial sensor package, in which case three channels of data with specific directional responses are produced for each array element. The method also applies to other multicomponent arrangements that allow the acquired data to be processed into an orthogonal basis. The method, however, is agnostic to the type of sensor used to acquire the signal so long as the sensor acts as a point-sensor, the final output is a digital stream proportional to the amplitude in the seismic wavefield, and the sensors produce wavefield measurements that are coherent from sensor to sensor. Any of a standard geophone or accelerometer, or an omnidirectional seismic sensor, or an optical point-sensor, which generates an output proportional to the measured amplitude or a time derivative of the amplitude of the seismic wave, is an exemplary illustration of a useful sensor type.

### Specification of Compact Volumetric Phased Array

This section describes how Compact Volumetric Phased Arrays of seismic sensors are specified and these specifications are referred to in the descriptions of the methods. For a compact volumetric phased array, the maximum distance between vertices of the bounding polytope must correspond to a design frequency that exists within the band of interest and within the primary frequency response band of the point sensors used as array elements. Advantageously, the array may be in the form of a three dimensional bounded convex polytope. The compact array is also bounded such that elements lie within a particular distance of each other, and that distance is namely a coherence length defined for a specified wavelength and corresponding preferably to the maximum frequency of interest.

The array elements are generally arranged with spacings d corresponding to one or more design frequencies f_{d} and arranged in any of multiple ways to enclose a volume so long as all sensors are either located at vertices or interior to the boundaries of the polyhedron. Advantageously, the array may be a volumetric, bounded convex polytope, where array elements are the vertices of the polytope. The inter-element spacings along the surface of the bounding polytope largely correspond to the minimum design frequency of the array. Generally, these elements along the surface of the bounding polytope correspond to the greatest distance from the array centroid or a specified axis of symmetry.

The element spacing, d, depends upon the frequencies of interest and a design frequency, f_{d}, which may be within the upper frequencies of the frequency band of interest. The corresponding design wavelength is then λ_{d}=c/f_{d} where c is the phase velocity of the media into which the array is emplaced. For media propagating elastic waves, c may be the compressional wave velocity or the shear wave velocity or may correspond to any of the velocities determined for relevant surface waves (e.g., Rayleigh waves or Scholte waves or Stonely waves). The ideal element spacings d are based on the design frequency, and then derived from the design wavelength as d=λ_{d}/2. Because seismic propagation involves multiple types of waves travelling at different phase velocities c, a single element spacing d will correspond to more than one design wavelength. Furthermore, array geometries are possible that would include more than one design frequency.

As is generally known, the array aperture determines the ability to resolve the angle of arrival of an incoming signal. The specific aperture as referred to herein is the maximum distance across all elements contained in a plane oriented perpendicular to the direction of arrival of a plane wave, also called the ray vector. Therefore, unless the array geometry is in the form of a regular sphere, array aperture will be a function of both azimuth (measured clockwise from north within a horizontal plane) and depression angle (measured down from the horizontal plane).

General signal and noise considerations limit the array aperture to be not much greater than the seismic wave coherence length of the maximum frequency of interest. This is important for the beamforming operation to yield a gain over the maximum desired frequency bandwidth. The signal spatial coherence is measured using the cross-correlation between seismic signals of interest sensed at two spatially separated sampling points (e.g., array elements) for all times. It is also of importance that the noise within the band of sensitivity not be coherent (as a function of wavelength), such that when beamforming is performed, the noise is not coherent from sensor to sensor and so will appear more or less as a random process and destructively interfere. This is accomplished by spacing the sensors far enough apart that noise wavelengths are spatially sampled at roughly the noise half-wavelength distance but not less than the noise quarter-wavelength distance such that adjacent sensors can be considered as largely independent and the noise time series at those frequencies are largely not coherent.

In contrast to the spatially very large geophone deployment characteristics of permanent reservoir monitoring systems, the disclosed methods operate on data delivered from compact volumetric phased arrays that are dimensionally much smaller and have an outward looking ability of beamforming with array aperture sizes on the order of several meters. Another distinction between standard permanent reservoir monitoring systems and phased array designs suitable for use with the invention is that application of the two-dimensional array designs used for reservoir monitoring and characterization would result in spatial aliasing for signals. This aliasing would dictate that the sensors could only be processed as stand-alone instruments (such as is performed with standard seismic survey data) and not as a coherent array for the purposes of beamforming with a known and predictable phased array response pattern (i.e., beam pattern) not dependent on an apparent phase velocity.

The signals data along with array element and data channel metadata acquired with the compact volumetric phased array system 206 is the input data required by the processing method implemented by “Seismic Survey Processing Systems & Methods.” The module labelled Seismic Survey Processing System 216, includes an implementation of the method in the form of sets of computer instructions. The compact volumetric phased arrays, array interfaces, and data acquisition components as shown in the seismic data acquisition and processing system 200 can be lumped together as the “Array System.”

### Standard Subsurface Imaging Using Individual Channels

In comparison to the seismic data acquisition and processing system 200, data from seismic survey lines or areal deployments consists of many shot-point geophone-receiver pairs providing wide-angle ray path geometries for sampling a depth point and allowing a high seismic fold as defined under “Definitions.” The simplest approach combines traces with the same shot-point, receiver point, or midpoint/depth point into “gathers” prior to applying propagation path corrections to the received signals and stacking (averaging) the gathers, where the “gather” is a collection of time series traces. Traces can be gathered in different domains according to seismic processing objectives, e.g., shot gathers, receiver gathers, and common midpoint gathers. Moving the shot and/or receiver points thereby providing a geometric sampling diversity of angles and offsets enable subsurface volumes to be sampled and visualized.

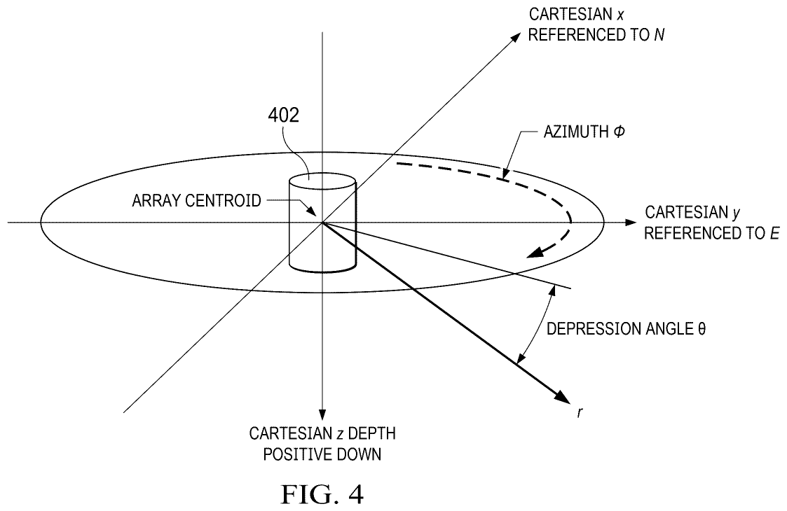

FIG. 4 a graph showing an example compact volumetric phased array 402 represented in a spherical coordinate system. In FIG. 4, the origin of the coordinate system may be anchored to a reference position in the compact volumetric phased array 402, such as the array centroid, and local coordinate system positions and angles may be tied back to a geographical north-east-vertical reference frame. Referring to FIG. 4, in the context of defining the direction from which a signal is received, the azimuth angle and the depression angle are angles about the origin, representing a decomposition of the arrival angle of the signal ray vector. The azimuth angle is an angle about the origin and within the horizontal plane containing the horizontal axes North-South, East-West, and the origin; and the depression angle (or dip angle) is an angle of displacement about the origin in a vertical direction below the horizontal plane. For the examples citing a single geophone (in a spread of geophones) as the receiver, the origin is at the location of the geophone. For the examples citing a volumetric array, the origin is roughly at the centroid but may differ from the exact centroid location to be at the location of a particular sensor located near but not at the centroid.

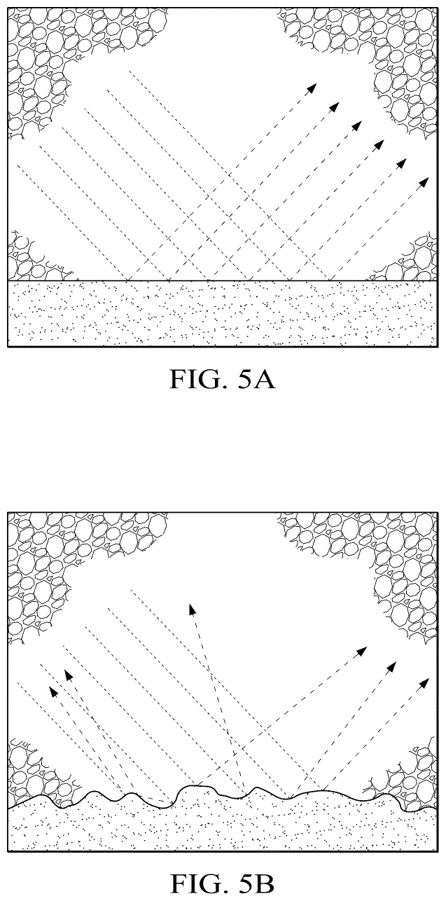

The general method of moving shot points and receiver locations is commonly taught in texts as the seismic reflection method. The method is based on acquiring waveform data at geometries that correspond to specular reflections from geologic structures. FIGS. 5A and 5B show examples of specular reflection, and scattering and diffraction, respectively. Specular reflections as shown in FIG. 5A are understood as the mirror like reflections from a surface, typically modeled with Snell's law and based on ray theory approximations for interactions of a propagating elastic waveform with geological structures, and where geologic structures local to the reflection point are approximated as a planar surface. Many of the basic principles are drawn from similar analysis performed in geometrical optics. In the ray theory method, the ray path is a trajectory along which the energy of the seismic wave propagates and can be traced from the shot point to the receiver, taking into account the properties of the geology.

FIG. 5B in contrast shows that diffraction can be understood as reflections from a rough surface, or a surface with changing properties of density, porosity, composition, and velocity, and can be described by the Huygens-Fresnel principle.

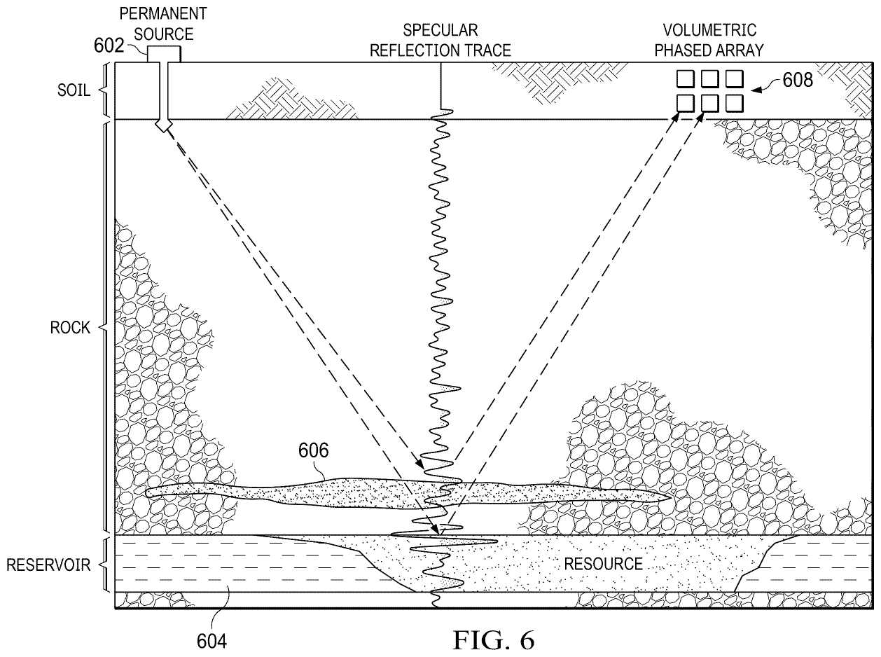

In comparison, permanent sources are used at fixed locations. These systems are designed to be remotely and autonomously operated, and controlled by automatic system software such that they operate completely unattended, and may be part of a strategy for sparse monitoring of the underground assets and automating the change-in-state assessment to produce near-real time reporting. FIG. 6 is a schematic of an example source 602 and receiver 608 arrangement showing specular reflection points at a reservoir 604 and an anomaly 606. Ray paths from the specular reflection points to the receiver 608 are also shown. The receiver 608 may be a compact volumetric phased array. In the example shown in Error! Reference source not found., the source 602 is a fixed permanent source that may be a pedestal-mounted source where the pedestal is a metal-bore pipe stem (also called a screw pile) drilled into the ground through the upper weathering layer with a source attached at the surface. The pipe stem passes through the alluvial and weathered surface, and the bottom-most part of the piling (or toe) is emplaced into a non-weathered stratum that is of a higher lithification grade than surface materials. The source mounted at the top of the pedestal at ground level imparts energy and the pipe stem transfers the energy such that the bottom of the pipe stem acts as the primary source of seismic energy, thus avoiding complicated effects and attenuation of propagating through near-surface weathered layers. The resource occupies the reservoir poor space. Alternately, a waste product may occupy the reservoir poor space.

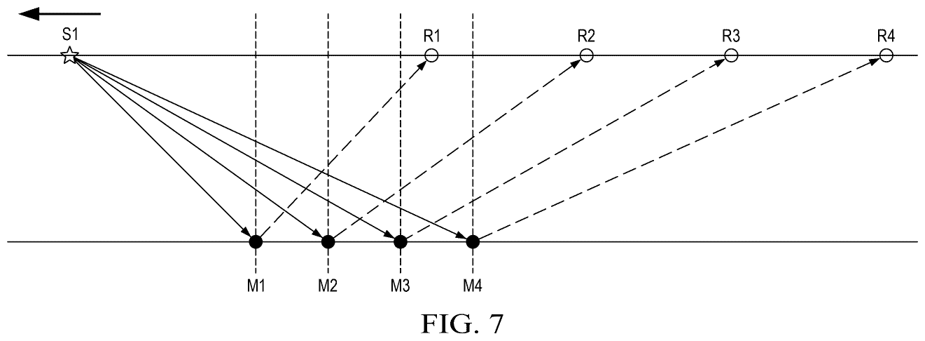

For standard single component surveys, the receiver is a vertically oriented geophone, with multiple geophone units distributed along a line with the source as shown for example in FIG. 7, or also as receivers distributed in a 2D area on the Earth's surface. FIG. 7 shows a source S1, and receivers R1, R2, R3, and R4, where the source S1 moves to the left while the receivers, R1-R4, are left stationary until the planned pattern of source-receiver offsets for sampling the geology is completed, then shifted to new locations within the larger plan for subsurface sampling. This procedure is repeated for two dimensional profile lines or three dimensional volumes (FIG. 1) until the geology is fully sampled with multiple specular ray paths per reflection point. For specular reflections, the reflection points coincide with the midpoint between the source and receiver, labeled as m1, m2, m3, and m4. Ray paths are shown as solid lines from the source to the reflection point, and as dashed lines from the reflection point to the receivers R1-R4. As the source S1 moves from point-to-point a pattern is created whose geometry contains the source and receiver positions. Commonly, receiver positions also move following the sources in a “roll-along” manner. The source S1 may be a frequency controlled vibrational unit, or an impulsive source. For multicomponent surveys, the receiver is a tri-axial sensor having orthogonally oriented geophones, and the source may be a vertical frequency controlled vibrational source or an impulsive source, such that for each shot point three received signal records are recorded. However, multiple directional vibrational seismic sources may be used (one vertical, and one that vibrates in the horizontal plane and is repositionable) such that for each shot point nine received records are generated when using multicomponent sensor stations.

### Conventional Specular Reflection Vs. Diffraction

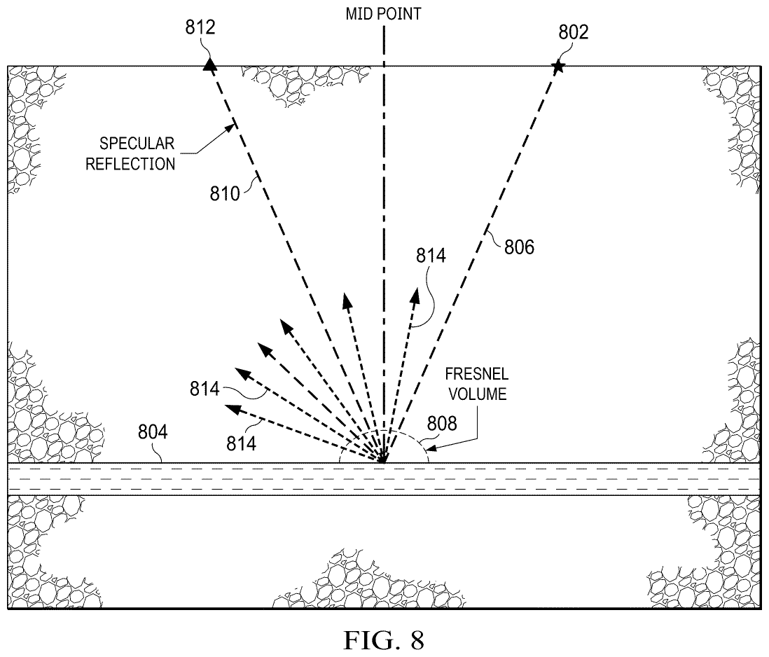

Using rays to represent wave travel assumes that the reflection only occurs at a point. This approximation is generally violated as a recognized reflection in a seismic record is comprised of energy returning from a larger area of the surface which may not be uniform and where the reflection point may include its own topography and varying geophysical properties. FIG. 8 illustrates an example of specular reflection in a profile view compared to scattering and diffraction. In FIG. 8, a compressional wave is created at a source point 802, and propagates to a non-unform interface 804 between two layers along a ray vector 806, where the wave interacts with a Fresnel volume 808 to produce specular reflection 810 that propagates to receiver 812. The compressional wave is also defracted within the Fresnel volume as defractions 814. The Fresnel volume 808 is a three dimensional region that affects a wavefield around the reflection point in the vicinity of the central ray. A Fresnel zone is the area along the surface of the geologic structure containing the reflection points from which reflected energy arriving at a receiver has phases differing by no more than a half cycle and interferes more or less constructively.

For a given source-receiver geometry, outside of this Fresnel zone, non-specular interactions take place including scattering and non-constructive interference. In addition, when the geologic structures include bending layers (anticlines and synclines in geologic terms) with radii of curvature less than a few wavelengths, or a reflector is terminated by a fault or fracture zone, or a “pinchout” of the strata, the Snell's law description of the reflection-does not adequately describe the physical interaction between the wavefield and geology that results in diffracted energy. Three-dimensional geometries and interactions with propagating seismic energy are inadequately described with a two-dimensional Fresnel zone and better described using a Fresnel volume 808. These diffracted wavefields can be collected from non-specular geometries, and the geophysical community recognizes useful information about the character of the geologic structures is contained in these wavefields. In particular, diffraction imaging enables resolving geologic structures that are of high interest for reservoir engineers and operators such as faults, fracture zones, erosional unconformities, and stratigraphic pinchouts.

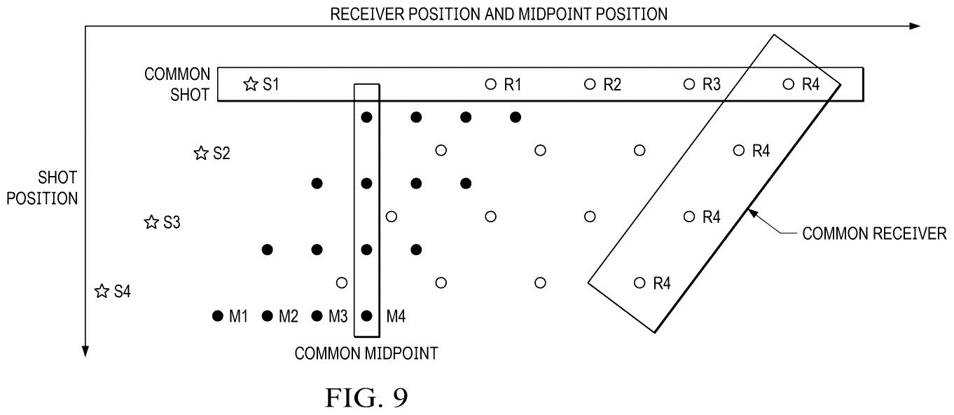

Reflection survey seismic “traces” are recorded time-segments relative to zero-times of a seismic source. Collections of seismic trace time-segments can produce two-dimensional vertical seismic sections that sample the geology in a vertical plane, or higher-dimensional collections that sample the geology in a three dimensional sense, assembled into volumes containing multiple trace time segments where the first data dimension is always time with respect to the source shot time. FIG. 9 is a stacking diagram showing receiver and common midpoint positions as a function of common shot positions. In FIG. 9, receiver positions are shown as open circles, shot positions are shown as stars, and common midpoint positions are shown as closed circles. The stacking diagram of FIG. 9 illustrates concepts of sorting the data into gathers based on some common parameter (e.g., shot position). Common gather types include common-shot (traces recorded for the same shot position), common receiver (traces recorded from the same receiver), and common midpoint (CMP) or common depth point (CDP), generally assigned under the assumption of specular reflection. Other useful gather domains for processing are common offset and common azimuth. Any of these gathers may be then manipulated to form an image of the subsurface. The most common approach is to sort the data into CMP gathers representing a series of reflection geometries about the CMP for increasing time in the records representing specular reflections from strata of increasing depths at a diversity of source-receiver offsets. The common approach is to apply corrections based on the moveout of the reflection, and other operations to adjust timings of what may be diffracted energy arrivals, such that when the records are superimposed (stacked), the seismic amplitudes emphasize the point of reflection or diffraction. This class of processing methods is generally known as seismic migration.

However, conventional seismic migration methods for imaging the subsurface (e.g., Kirchoff migration) rely on effectively projecting the recorded wavefield back into the earth model (i.e., usually represented as seismic velocity) to each possible diffraction/reflection point according to the geometry and two-way travel-time information for source-receiver pairs. For typical seismic surveys with 2D or carpet geophone deployments using single component geophones (or effectively a single component geophone if summing together a geophone receiver group), there is often no way of determining a precise unambiguous angle of arrival of the incident wavefield because what is measured across the typical seismic survey-network of sensor stations is an apparent velocity of the wavefront.

The apparent velocity of a wavefront cₐ is the ratio of the distance between two receivers on a surface Δx, usually the surface of the ground but can be a plane defined by a borehole and the wavefront of a signal, to the difference in the arrival times Δt, given by

$${c}_{a} = \frac{Δ x}{Δ t} = \frac{{c}_{p}}{sin sin θ} = \frac{2 π v}{{κ}_{a}} .$$

Dividing this equation by the frequency yields

$${λ}_{a} = \frac{{λ}_{p}}{sin sin θ} = \frac{2 π}{{κ}_{a}} .$$

Given these relationships between a wavefront and a two dimensional spread of geophones on the surface (either a line or planar “patch”) or geophones arranged in a line within a borehole, it should be evident that there is no way of independently measuring both the true phase velocity and the arrival angle, or the true wavelength and the true wavenumber.

A result of this dependence is that, in applying migration algorithms, the portion of the recorded wavefield associated with a specific reflector will be projected throughout the entire three dimensional volume to all possible diffraction/reflection points that correspond to a geometry and two-way travel-time information associated with a specific source-receiver pair. A diffracted signal arriving at a single receiver station is assumed to be present because there is no easy way of determining the arrival angle as a function of time to the granularity required for migration. Repeating this process for every source-receiver pair usually results in the correct diffraction point (or reflection surface) being imaged/highlighted through constructive interference, but it also can introduce or leave a significant amount of noise in the image that might obfuscate other diffraction points or reflection surfaces (generally called “smearing”), and the process is computationally intensive.

### Subsurface Imaging Using Compact Volumetric Arrays

Orthogonal, Mega-bin, Fully Sampled, Double-weave, and Slant are survey design strategies for source point and receiver station location geometries for sampling a three-dimensional volume of earth using metrics and concepts of “seismic fold” and the “stack array,” e.g., as illustrated in FIG. 9. Note that when discussing active source three-dimensional seismic surveys, the emphasis is on sampling and imaging a large and wide three dimensional earth volume using an arrangement of controlled active sources and receivers on the surface of the earth, a primarily two-dimensional or planar arrangement of sources and receivers. Seismic fold is the multiplicity or redundancy of seismic wave sampling of mid-point bins, assuming specular reflections at multiple depths corresponding to the source-receiver midpoint bin, using the variety of source-receiver offsets and azimuths coinciding in that bin. Seismic fold buildup for a continuous stack array sampling is a proxy for improved imaging capability, including improved anti-alias spatial “filtering” that removes interfering signals originating with source, back-scattered, surface related, and guided wave noise from “stacked” processed images exploiting specular reflections. In conventional seismic processing methods, the stacked processed images derived from “common mid-point” or “common depth-point” data gathers of the receiver data (traces) acquired with high seismic fold source-receiver geometries are the goal.

It is possible to achieve a favorable two-dimensional (profile) survey stack array fold buildup when source point spacings equal the receiver spacings especially as spacing intervals decrease. However, as the source point-receiver geometries become sparse due to operational constraints, attaining a desired fold buildup becomes more difficult and may be impossible. Nevertheless, survey design strategies exist for sparse source or receiver locations for generating two-dimensional profile samplings of the desired depth intervals within an optimal source-receiver offset range for low-fold acquisition geometries. Compact volumetric phased arrays provide receivers ideally situated for sparse “low fold” optimum-offset imaging with specular reflections, where the source-receiver offsets are selected so the reflection time from the horizon of interest is later than direct arrivals and their reverberations but earlier than the arrival times of surface waves and other source-generated noise. However, when using data provided by low fold arrangements, lack of the data-redundancy described as “seismic fold” due to the reduced aperture and the fixed-array positions limits the available methods to process out competing signals such as ground roll and air waves. When using data provided by a compact volumetric phased array alone in comparison to conventional wide area three-dimensional surveys and deep borehole VSP arrays, conventional techniques to process out the interfering signals like ground roll and air waves are not available, but phased array signal processing methods related to acquired coherent signals and the directivity patterns of the arrays are enabled by the volumetric phased array design. This provides an advantage for these permanent volumetric phased arrays over other receiver deployment geometries, in particular sparse receiver deployments, that do not enable phased array processing techniques.

As previously discussed, types of seismic “gathers” and their physical dimensions are determined by processing objectives and underlying seismic acquisition geometry. Gathering is an approach to sorting the seismic traces acquired from individual receivers for side-by-side display having a basic acquisition parameter in common. Standard gathers include common-midpoint, -offset, -depth point, -conversion point, -shot point, angle/azimuth, and receiver gathers. The different gather collections are fit-for-purpose to processing objectives. To represent a space-time proxy image of subsurface cross-section or volume, a compact volumetric phased array shot gather does not provide an ideal spread of receivers from the perspective of a conventional surface seismic survey shot due to the array's limited aperture compared to the conventional geophone carpet deployment that can be used to create high fold common mid-point gathers. It is more appropriate to group the compact phased array data into common receiver gathers containing data acquired from multiple shot locations along a two dimensional profile line (or a carpet patch for a three-dimensional volume sampling) to represent a subsurface cross-section or cube. This is mainly due to the fixed emplacement of a compact volumetric array with limited areal coverage of its point sensors.

In addition, in conventional seismic data processing using data acquired with a two-dimensional network spread of sensors, data is sometimes sorted into super gathers where multiple adjacent bins along a particular gather dimension are combined. The super gather sorts merge data from the conventional survey geometries into a single bin or box (three dimensional version of the bin) representing an averaged common depth point when the initial data density is not sufficient to generate measurements of attributes, such as from amplitude vs. offset analysis, while preserving amplitude information and the offset dimension. Depending on the context, the conventional survey super gather grouping may have different objectives such as data randomization, data regularization, computational efficiency, or building higher-fold boxes when stacking. However, the super gather utility is limited to cases of non-coherent noise because coherent noise will be reinforced for these groupings.

For example, the data traces from spatially adjacent shots and multiple adjacent receivers may be combined into a single shot super gather group containing the same repeated receivers for each combined gather of multiple shots. Super-gathers are not limited to the shot dimension but in principle can be formed from other base survey dimensions, such as common offset from a reflection point for three dimensional seismic surveys, to suite objectives for individual surveys. Depending on the application, super-gather boxes may be unique or can overlap. However, for super gathers generated from conventional survey plans, independence of the subsurface sample points is lost for all cases because of the combining of traces in an overlapping fashion. Furthermore, this may lead to creating a “spurious” and non-physical precision or resolution in the imaging results even while visually improving the image.

Traces acquired using point sensors from a volumetric phased array can be grouped into supergathers to refine the trace midpoint spacing assuming that the aperture of the array is at least equal to the shot spacing (to avoid gaps between the shots). The volumetric phased array supergather (VPA supergather) method has the advantage of producing a higher resolution image constructed over a subsurface swath that generally avoids problems due to spatial aliasing and is not limited to common shotpoint or common offset super gathers. In all cases, the VPA supergather method will produce a better general result than treating the compact volumetric phased array as a receiver group and summing all the channels to create a single averaged response. The primary difference in VPA supergather method versus traditional super gather approached is that the VPA supergather takes advantage of the extra dimensionality furnished by data from a volumetric phased array for noise reduction not available when using traditional planar two-dimensional or one-dimensional linear sensor surface deployments. The additional vertical dimension of the volumetric phased array enables beamforming the data from vertical subgroups of sensors prior to forming the VPA supergather, allowing any of the phased array processing techniques for reducing or cancelling coherent noise to be applied over the vertical aperture of the compact volumetric phased array. The net advantage of the VPA supergather approach is to build up a more dense reflection point sampling along a subsurface swath while improving the SNR over what can be performed with conventional survey plans without necessarily requiring the sacrifice of independence between the subsurface sample points in the swath. The method can then be applied to produce enhanced common receiver VPA supergathers with independent and spatially dense but limited-area/volume subsurface measurements, which is not possible with traditional network deployments. Nevertheless, this approach does not take full advantage of the phased array design and generally will not generate the signal processing gains that full array beamforming methods produce especially for arrays constructed under minimum array gain requirements of ˜15 dB over a single channel.

The compact volumetric phased arrays are designed with some knowledge of the elastic wave velocities of the media into which they are installed. The design is chosen to enable coherent processing by way of operations related to gradiometry, beamforming, and similar processing steps that allow for maximizing SNR or allow deriving additional information only maximally effective through volumetric phased array sampling.

### Phased Array Signal Processing Approaches: Gradiometry

For a compact volumetric phased array with array elements instrumented with single component geophones (e.g., with vertically orientated geophones), the disclosed embodiments of the method include gradiometric calculations that allow spatial gradients of the recorded wavefield to be derived in three orthogonal directions. Applying the specified embodiment method then yields three additional independent components of data. For any compact volumetric phased array having array elements comprising three-component geophones (i.e. multicomponent geophones) or similar sensors having a directional response pattern, applying the specific disclosed embodiment enables the spatial gradient of the recorded wavefield to be derived as nine additional independent components which, according to wave gradiometry, see, e.g., Langston, C. A., Wave gradiometry in two dimensions, Bulletin of the Seismological Society of America (2007), can be combined with the recorded geophone data to infer propagation information of the recorded wavefield in three dimensions (e.g., as a function of azimuth, depression angle, and phase velocity respectively).

The gradiometric propagation information, derived continuously for continuously sampled data, can be used in conjunction with conventional ray-centric imaging/migration algorithms to construct a beam and/or emphasize portions of the recorded wavefield that separates a specific phase, reflection, refraction, or diffraction, and incident angle/direction according to a specific subsurface geologic structure or volume, and then provides a time shift or correction to align that specific phase with the source of the reflection, refraction, or diffraction. Using this method, the contribution of specific portions of wave energy in the recorded signals is better focused to the incident angles/directions associated with specific diffraction/reflection waveform energy, avoiding “smearing” of the energy across a larger portion of the image space. Since the propagation direction of the recorded energy can be resolved across the SADAR array for the individual potential reflection arrivals within some range of angular and projected back to the migration response, the gradiometric information derived from the volumetric phased array may be used to limit the locations where the recorded data are projected thereby reducing the amount of potential noise introduced into the migrated image, and thereby improving the image. over standard receiver gathers. The method is implemented as a set of computer instructions for constructing the gradiometric series and a separate set for migration-like operations. Again, the method is unique to data supplied using compact volumetric phased arrays.

### Phased Array Signal Processing Approaches: Beamforming

A class of coherent signal processing operations applied to data measured using phased arrays is largely designated as “beamforming.” This section discusses beamforming in the context of a central operational step required for one embodiment of the method, resulting in enhanced signal-to-noise ratio for signals arriving in preferred orientation and preferred phase velocity of the beam specification, called the beam main response axis or MRA, as usually portrayed using an array response pattern (Error! Reference source not found.).

The compact volumetric phased arrays enable extracting characteristics about the arriving seismic energy, the separation of signals that may simultaneously arrive at the array, wavenumber filtering of undesired seismic energy arriving at the array such as ambient noise or clutter source generated signals, and constructing an image of the geological structure using specifically highlighted signal components. In one embodiment of the method, the techniques for processing the seismic data supplied by the compact volumetric arrays perform separation of signals, filtering operations, and noise suppression to maximize the received signal, generally known as beamforming. Beamforming of the received seismic signals, also known as beam-steering in these contexts, requires signals data acquired using a system designed as a phased array, and the method is specific to data acquired using compact volumetric phased array designs. However, the methods applied in this system may take advantage of the full variety of conventional and adaptive beamforming described in phased array signal processing publications to produce subsurface images.

For these purposes, beams are specified as targeting signals originating from depth points within a geologic asset. The signals are considered as specular reflections or diffractions from controlled sources used in a seismic survey. The purpose of the seismic survey is to map and characterize the state of a geologic asset to include any reservoir, caprock, or geologic structure important for maintaining the value and integrity of the geologic asset. The parameters defining the beam main response axis (MRA) are based on the velocity model of the geologic stratigraphic section for capturing desired reflections, refractions, or diffractions.

The pointing direction of a beam is specified according to the direction of the MRA, azimuth angle Φ, and depression angle θ, where the latter two are defined in Error! Reference source not found. for a spherical coordinate system. In addition, the full specification of the beam includes phase velocity c. Beams with the same pointing direction specified using phase velocities corresponding to the compressional wave or shear wave velocity measured across the array are then unique beam MRAs specified as a function of (φ, θ, c). Alternately, the phase velocity c can be expressed instead as a slowness, which is the reciprocal of the phase velocity or

$$( \frac{1}{c} ) .$$

Note again that the phase velocity c and the slowness, expressed as

$$( \frac{1}{c} ) ,$$

are the measured actual phase velocities, and not an apparent phase velocity as is measured with a planar or linear phased array. The targeted beams then are processed further to filter undesirable energy arrivals, or correct for normal moveout and similar effects, or provide general signal enhancements, and the results are assembled into images similar to receiver gathers.

The disclosed embodiments of the method produce multicomponent beams when the input from the compact volumetric phased array elements originate from multicomponent orthogonal arrangement of vector sensors (also called multicomponent stations) for all elements. For example, where one component is mathematically manipulated to be aligned with the beam MRA (inline component) to maximize the power in the compressional wave direct arrival, and then one component is mathematically manipulated to be aligned perpendicular to the MRA and in the horizontal plane (transverse or crossline component), and one component is mathematically manipulated to be aligned perpendicular to the MRA and in the vertical plane containing the MRA and the source (the sagittal component). Therefore, for each shot point at least three beams may be created specifically to separate preferentially polarized waveforms for each phase velocity.

When the seismic source equipment includes vibrational units capable of producing horizontal vibrations (in the plane of the Earth's surface) as well, then for each shot point nine total beams may be created to separate preferentially polarized waveforms for each phase velocity and mode of source vibration. The decomposition of the wavefield into these components aids in the separation and identification of the different modes of elastic waveform propagation, such that separate compressional and shear images can be constructed from the beamformed data. Shear wave images are considered beneficial because shear waves are sensitive to different geophysical parameters or react differently to the geophysical state of reservoir systems compared to compressional waves. See, e.g., Davis, Time-Lapse, multi-component seismic monitoring of geomechanical changes in reservoirs, First Break, (January 2023).

Furthermore, in all cases generating beamformed data, the disclosed embodiments of the method output data records with a significantly enhanced signal to noise ratio compared to any single channel for the received signals, resulting in the ability to resolve geologic features at a greater depth. At the same time, the random noise and coherent clutter arriving at the array with angles other than the MRA and outside of the beam primary response lobe is suppressed, an equally important result. Lastly the beamforming procedure improves the lateral resolution not just by improving the SNR, but also because beamforming strongly reduces the Fresnel zone to the common area for all elements in the array.

In addition, for embodiments designed around permanently emplaced sources, automated beamforming of the array provides a single beam-targeting the specular reflection from the depth point of the horizon of interest, or similarly a suite of beams targeting the specular reflection from individual geologic volumes of interest, or similarly targeting the specular reflection from other subsurface geologic structures that may be used as control points for determining a change in state.

To the extent other methods based on beamforming seismic data have been based on data provided by sensor arrays, the arrays are not designed as phased arrays, and/or are either linear arrays or planar arrays and not volumetric arrays, and/or supply data that does not allow beamforming along multiple randomly chosen main response axes. In the past, beamforming techniques have been suggested for locating the depth of a leak in a working borehole (see U.S. Pat. No. 10,598,563). Use of a linear array to detect acoustic sources associated with a leak (e.g., see, again, U.S. Pat. No. 10,598,563) is not relevant to the current problem as there is an inherent ambiguity in azimuth angle about the linear array axis, so the array is not able to provide a complete measurement of angle of arrival, or to separate signals simultaneously arriving at the array. In addition, a linear or areal array cannot directly measure the phase velocity of the incident seismic wave.

For example, a seismic wavefront incident on a linear array in a broadside aspect angle has an infinite apparent velocity, because that apparent velocity is a projection of the actual phase velocity across the sensor array. Extracting any actual phase velocity across the array then requires knowing the true angle of arrival. But extracting the actual angle of arrival from the apparent phase velocity requires knowing the actual phase velocity. Thus, it is impossible to resolve the ambiguity. Similarly, horizontal planar arrays used for angle-of-arrival determinations have limited application for large aperture arrays, because for vertically incident p- or s-waves the apparent velocity is infinite across a planar array parallel to the earth's surface. It becomes impossible to separate seismic energy phases based on phase velocity, and difficult to assure that any measure of angle of arrival is correct for steeply incident waves. Therefore, without additional information, it becomes impossible to determine the actual angle of arrival and the actual phase velocity independently and unambiguously for linear or planar phased arrays.

Prior applications of volumetrically distributed geophones, such as emplacing several strings of geophones, where the geophones are distributed along the string with planned spacings, have been applied to detect and locate microseismic events associated with geologic reservoir engineering activities. However, the vertical strings are not designed or emplaced to provide specific array element spacings between the geophones on different strings, and also not between vertical strings, and therefore do not maximize the coherence or received signal SNR in any volumetric sense. Therefore, no direct unambiguous angle of arrival or independent phase velocity measurement is possible, and therefore such methods do not support the beamforming computations described in embodiments of the method.

The disclosed embodiments of the method produce multiple directional beams that are specified as pointing along an MRA defined as a function of depression angle and phase velocity. The method that includes beamforming as a function of depression angle and measured phase velocity allows constructing a suite of beams with a variety of depression angles in a vertical plane (along a fixed azimuth), the depression angle being independent of phase velocity or apparent phase velocity. The suite of beams having differing depression angles enables in part separation of specular reflections from other energies arriving at the array. The beam MRAs, as a function of depression angle, azimuth angle, and phase velocity, are specified with a series of parameters used in computer instructions to automatically form the suite of beams per shot point record.

A beamforming operation, e.g., a conventional delay and sum beamformer, may be implemented in the time domain by applying time delays associated with a hypothetical plane wave impinging upon the sensor array along the specified MRA and its phase velocity to the data received in each frame originating from each individual array element, and then summing the data from all array elements to produce a new set of data frames (a delay-and-sum beamformer). This operation is repeated for each defined beam MRA and velocity.

Use of beamforming algorithms other than the conventional delay-and-sum beamformer are contemplated. Types of beamforming algorithms useful for incorporation in the method include the Bartlett beamformer and algorithm, the Minimum Variance Distortionless Response beamformer, the Maximum Likelihood beamformer, Multiple Signal Classification (MUSIC), the Space-Time Adaptive Processing beamformer, non-linear beamforming approaches, and similar algorithms that are not excluded from being implemented with the disclosed volumetric array hardware configurations.

The following mathematical description is exemplary for conventional beamformer operations. The array processor receives data which is entered into the array queue for processing. The processor assumes input that consists of the received signal of interest and superimposed noise processes which may or may not be random and non-coherent across the array. The received signal of interest is assumed to be a bandpass signal of the form:

$$s ( t ) = a ( t ) cos ( 2 π {f}_{c} t + ϕ ( t ) ) \qquad ( 1 )$$

where:
f_{c} is the center frequency, a(t) represents a slowly varying amplitude, and φ(t) represents a slowly varying phase factor. Typically, for active source surveys the source signal may be a swept-frequency waveform where f_{c} is a function of time. However, s(t) may take the form of an impulse in time as well as other representations that do not restrict the method.

Equation (1) can then be expressed as a complex sinusoidal kernel as

$$\tilde{s} ( t ) = a ( t ) {e}^{j 2 π {f}_{c} t + j ϕ ( t )} \qquad ( 2 )$$

also known as the analytic signal.

Assuming the incident signal conforms to a plane wave, and the signal observed at one array element can be characterized as a delayed version of the signal observed at another element in the same array, the analytic signal observed at the lth sensor is then:

$${\tilde{s}}_{l} ( t ) = {\tilde{s}}_{1} ( t - {τ}_{l} ) \qquad ( 3 )$$

where the delay τₗ depends on both the position of the lth element relative to the first and the angle of arrival of the plane wave impinging upon the sensor array. The additional distance the wavefront travels to reach an element a distance d away in a three-dimensional geometry is:

$$d cos ψ \qquad ( 4 )$$

where ψ is the angle between the line connecting the two elements and the direction from which the plane wave is propagating (the unit vector normal to the plane wave front).

The time delay between the signal arriving at a reference sensor, or a fiducial point within the geometry of the array, defined at a position R in the array and the lth sensor can then be written as

$${τ}_{R l} = \frac{{d}_{R l} cos ψ}{{c}_{p h}} \qquad ( 5 )$$

where cₚₕ is the velocity of propagation of that particular phase or mode of vibration (i.e., compressional wave, shear wave, or surface wave) across the array. The numerator is the scalar or dot product between the vector from the array reference to the sensor and the unit vector normal to the plane wave front. The subscript R in the time delay τ_{Rl} will be taken as implied and understood, not appearing explicitly in the following equations. At the lth sensor then, the observed signal would be:

$${\tilde{s}}_{l} ( t ) = a ( t - {τ}_{l} ) {e}^{j 2 π {f}_{c} ( t - {τ}_{l} ) + j ϕ ( t - {τ}_{l} )} \approx a ( t ) {e}^{/ 2 π {f}_{c} ( t - {τ}_{l} ) + j ϕ ( t )} \qquad ( 6 )$$

where the approximation is valid if a(t) and φ(t) vary slowly over the measurement interval. This formulation is true for narrowband signals. When the source signal does not satisfy narrowband constraints, then a broadband beamformer must be used, accomplished by implementing a separate narrowband beamformer over every frequency bin in a defined band.

Starting with the signal component, the complex envelope of the signal measurement from the lth array element is

$${\tilde{s}}_{l} ( t ) \approx a ( t ) {e}^{- j 2 π {f}_{c} {τ}_{l} + j ϕ ( t )} = a ( t ) {e}^{- j 2 π {f}_{c} {τ}_{l}} \qquad ( 7 )$$

where the delay τₗ in the signal equates to a change in phase of 2πf_{c}τₗ. Arranging the signal measurements over the time period [τₚ, τₚ+τₚ] from the lth element into the lth column of a matrix yields:

$$X = [ \begin{matrix}{\tilde{s}}_{1} ( {τ}_{p} ) & ⋯ & {\tilde{s}}_{L} ( {τ}_{p} ) ) \\ {\tilde{s}}_{1} ( {τ}_{p} + {T}_{s} ) & ⋯ & {\tilde{s}}_{L} ( {τ}_{p} + {T}_{s} ) \\ ⋮ & & ⋮ \\ {\tilde{s}}_{1} ( {τ}_{p} + [ n - 1 ] {T}_{s} ) & ⋯ & {\tilde{s}}_{L} ( {τ}_{p} + [ n - 1 ] {T}_{s} )\end{matrix} ] \qquad ( 8 )$$

where:

$${T}_{s} = \frac{1}{{f}_{s}}$$

is the sampling period, n=Tₚfₛ for elements l=[1 . . . L], defined relative to R being the array reference point or reference element. This matrix can be expressed as the vector outer product:

$$X = a {d}^{T} \qquad ( 9 )$$

thus, decoupling the temporal structure into a and the spatial structure into d, and where the emboldened format indicates a mathematical vector in the usage of linear algebra, such as a column vector.

The sampled signal vector is:

$$s = {[ \begin{matrix}{\tilde{s}}_{R} ( {τ}_{p} ) & {\tilde{s}}_{R} ( {τ}_{p} + {T}_{s} ) & … & {\tilde{s}}_{R} ( {τ}_{p} + [ n - 1 ] {T}_{s} )\end{matrix} ]}^{T} \qquad ( 10 )$$

and the spatial structure of the signal is captured by a vector of phase shifts:

$$d = {[ \begin{matrix}1 & {e}^{- j 2 π {f}_{c} {τ}_{l}} & … & {e}^{- j 2 π {f}_{c} {τ}_{m}}\end{matrix} ]}^{T} \qquad ( 11 )$$

where the phases adjust for the time delays from the reference element. The vector d is known as the steering vector of the array because it points the beamformer to the arrival angle used to form the time delays, along a beam MRA.

The bandpass signal received by an individual element l in an array of sensors, impinging upon that sensor with angles (θ, φ) with respect to the coordinate system of the array may have the form:

$${y}_{l} ( t ) = {α}_{l} ( θ , ϕ ) \vec{s} + n ( t ) \qquad ( 12 )$$

where:
α(θ, φ) is a complex valued vector containing the amplitude and phase effects of propagation from a source to the individual sensors, n(t) is additive white Gaussian system noise, and |\vec{s}| is the absolute value of the slowness vector, the inverse of cₚₕ.

The spherical coordinate system used here is defined in terms of a radius, φ being an azimuth measured clockwise from north in a horizontal plane, and θ being a depression angle where positive sweeps down from the horizontal plane (e.g., Error! Reference source not found.). This is the standard spherical coordinate convention used for geographical reference frames except that positive θ (positive depression angle) is down, into the Earth.

The data frame of discrete time samples is then:

$${y}_{t , l} = {α}_{l} ( θ , ϕ ) \vec{s} + n , t = [ 1 , 2 , ... {N}_{frame} ] \qquad ( 13 )$$

where N_{frame} is the number of data samples in the frame.

A common data frame length, when taking into account frequencies, the signals of interest, timeliness, and processor capabilities may be at least 2 seconds. The record length can extend to many seconds to be the entire length of the usable record for an active-source survey, which then simplifies the data management process within the set of beamforming computer instructions.

Sequential data frames may overlap in time, such that there may be a ˜0% to ˜90% overlap of each sequential frame. It is convenient then to define an indexed data frame as

$${Y}_{FN , l} = {y}_{t , l} \qquad ( 14 )$$

where FN,l are simply unique identifiers or indices that allow the data frame to be uniquely associated with a slice of time and a particular channel/element.

Because the MRA vector is defined within the spherical coordinate system as the [azimuth, dip, slowness magnitude] coordinates where slowness magnitude is the inverse of the waveform propagation speed across the array, the mathematical space is discretized into a fixed set of grid coordinates that can be projected out from the origin radially with increasing radial values defining nested spherical shells of constant slowness magnitude.

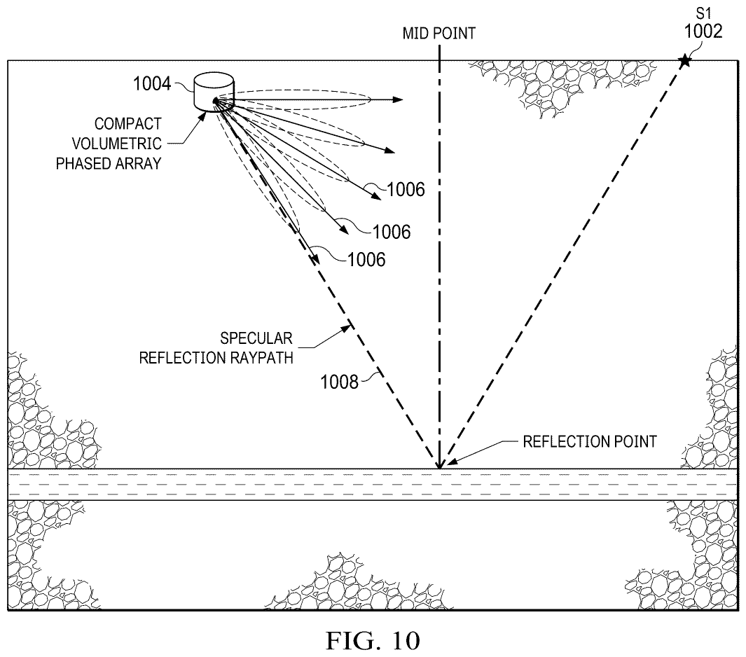

The specified slowness magnitude radii at the specified azimuth and dip angles are the set of beam MRAs chosen to highlight the energy prevalent in the seismic reflections, refractions, or diffractions from the desired geologic volumes (see e.g. Error! Reference source not found.). In a conventional multibeam approach, the step of defining these beam MRA geometries takes place in a planning phase ahead of the computation of the beams. After the beam MRAs are defined, the time delays required for each sensor to align a plane wave front normal to that response axis can be calculated (e.g., Equation 5 above). FIG. 10 shows example beam main response axes (MRAs) 1006 in an Earth volume containing a seismic source 1002 and a compact volumetric phased array 1004. Five example beam MRAs 1006 are shown in FIG. 10, along with their main beam response lobes, with one beam MRA aligned along the ray path 1008 for the specular reflection. These differences in time correspond to differences in phase for the individual frequencies.

Rewriting the time delay for Equation (5) in terms of vectors relative to a reference point R such as the array geometric center point, and relative to the plane wave wavefront results in:

$${τ}_{l} = \vert \vec{s} \vert ( {\vec{n}}_{l} \cdot \vec{m} ( θ , φ ) ) \qquad ( 15 )$$

where the angles θ and φ (depression angle and azimuth), are the spherical coordinate angles, \vec{m}(θ, φ) is the unit vector normal to the plane wave wavefront defined with respect to the array reference point R; implicit in the notation for τₗ and dₗ. Vector \vec{n}ₗ is the spatial vector from the lth sensor to the array reference point R (The distance differences are given by the dot product dₗ=\vec{n}ₗ·\vec{m}(θ, φ)), and |\vec{s}| is the magnitude of the slowness vector and the reciprocal of the magnitude of the velocity vector.

In order to use this in a beamformer application, the vector \vec{m} becomes the MRA \vec{M} (unit vector) pointing from the array reference point R in the angular direction (θ, φ) such that:

$$\vec{M} = - \vec{m} ( θ , φ ) \qquad ( 16 )$$

The phase shift then in units of radians for a given frequency and time delay is:

$$2 π {f}_{c} {τ}_{l} = 2 π {f}_{c} \vert \vec{s} \vert ( {\vec{n}}_{l} \cdot \vec{m} ( θ , φ ) ) \qquad ( 17 )$$

where f_{c} is the center frequency of a narrow band, so it immediately becomes apparent that the phase shifts need to be calculated for each discrete frequency, and for the beam with MRA pointing in direction \vec{M}

$$2 π {f}_{c} {τ}_{l} = 2 π {f}_{c} \vert \vec{s} \vert ( {\vec{n}}_{l} \cdot \vec{M} ( θ , φ ) ) \qquad ( 18 )$$

$${Φ}_{l} ( {f}_{c} , \vec{M} , \vert \vec{s} \vert ) = exp [ - j 2 π {f}_{c} \vert \vec{s} \vert ( {\vec{n}}_{l} \cdot \vec{M} ( θ , φ ) ) ]$$

where Φₗ(f_{c}, \vec{M}, |\vec{s}|) are the individual entries in the steering vector d for specific values of f_{c} and the beam MRA, and the specified value for slowness |\vec{s}|.

A weighting or shading function may be applied in some embodiments to provide a regularization of power in the array response side lobes. Shading is a well-known operation in phased array applications in fields other than seismology and can be very effective in removing interference of specious or undesired signals. Unfortunately, shading also carries the tradeoff of increasing the width of the main response lobe, thereby reducing angular resolution of the beam. A variety of common mathematical window functions such as Hann, Nutall, and Blackman-Harris can be used.

For conventional beamformers, the phase factors are calculated once for each beam MRA, as a function of frequency and slowness magnitude, when the array processor is initialized and then stored for use. The data from each of the elements in the array are then aligned and summed to produce a new data frame of data values. The operation is repeated for all combinations of the unique angles \vec{M}; \vec{M}=−\vec{m}(θ, φ) and the specified values of slowness |\vec{s}| to produce the time delays to be applied to the data.

The Fourier coefficients Fₗ, are determined for the frame Y_{FN,l}

$${F}_{l} = FFT [ {Y}_{FN , l} ] \qquad ( 19 )$$

specific to the data channel acquired from sensor l, and where FFT denotes the application of the fast Fourier transform. This transform into the frequency domain may apply Bartlett's method, Welch's method, the modified discrete cosine transform method, or related commonly known methods based upon the discrete Fourier transform and designed to mitigate spectral leakage or the effects of aliasing.

The Fourier coefficients Fₗ are then multiplied by the phasors as a function of frequency f_{c} to align the acquired data, and the result is summed over the L channels to create the frequency-domain beam representation:

$${F}_{\vec{M} , \vert \vec{s} \vert , {f}_{c}} = {\sum }_{l = 1}^{L} {F}_{l , {f}_{c}} {Φ}_{l} ( {f}_{c} , \vec{M} , \vert \vec{s} \vert ) \qquad ( 20 )$$

such that F_{\vec{M},|\vec{s}|} represents the frame of all of the complex coefficients spanning the frequency band present in the data frame xₜ for all channels l, aligned on the beam MRA designated by \vec{M}, at the slowness |\vec{s}|. Equation 20 may also be written as an average, or as a weighted average when applying shading.

Because the specific power P(\vec{M}, |\vec{s}|, f_{c}) sensed at the array, at frequency f_{c} and slowness space coordinates (θ, φ, |\vec{s}|), is:

$$P ( \vec{M} , \vert \vec{s} \vert , {f}_{c} ) = {‖ {\sum }_{l = 1}^{L} {F}_{l , {f}_{c}} exp ( - j 2 π {f}_{c} \vert \vec{s} \vert ( {\vec{n}}_{l} \cdot \vec{M} ( θ , φ ) ) ) ‖}^{2} \qquad ( 21 )$$

then

$$P ( \vec{M} , \vert \vec{s} \vert , {f}_{c} ) = {‖ {F}_{\vec{M} , \vert \vec{s} \vert , {f}_{c}} ‖}^{2} \qquad ( 22 )$$

The beamformed frequency domain frame for the beam with MRA \vec{M} and slowness |\vec{s}| may then be transformed back into the time domain:

$${Y}_{FN , \vec{M}} = Re [ IFFT ( {F}_{\vec{M} , \vert \vec{s} \vert , {f}_{c}} ) ] \qquad ( 23 )$$

where: Y_{FN,\vec{M}} is the time domain beam for the data frame with identifier FN, and for the beam with MRA \vec{M}, and for slowness |\vec{s}|, where the function IFFT indicates an inverse Fourier transform.

The above discussion outlines a conventional delay-and-sum beamformer computed in the frequency domain. Time domain equivalents apply a “shift and add” approach with similar output. Adaptive beamformers have a more complicated mathematical formalization requiring the data covariance matrix as input (for example), but the results can be cast into a similar final expression and output.

Furthermore, even the more fundamental beamforming methods allow modifying the shading coefficients to create a “null” in the beam response pattern. The null allows a large-scale reduction of the power from interfering coherent signals arriving at the array along a particular azimuth and depression angle. The more sophisticated methods allow manipulating nulls by zero forcing (zero forcing precoding in antenna arrays), to reduce the contaminating noise signals (clutter) arriving along specific directions other than the beam MRA. The variety of null steering methods also includes closed loop, direct solution, iterative approaches, and hybrid methods, for example.

Furthermore, beams may be “dynamically steered” such that the MRA changes as a function of time. Additional similar approaches exist where a composite beam may be built through time windowing multiple individual beams with different main response axes and either constructively or destructively summing the windowed results. These beamforming techniques are well known to those who practice the art, and all are included as alternate embodiments of the beamforming function in the processing sequence so long as they may be automated and apply to the goal of imaging specified reflection points within an earth volume using active source signals and/or surveys.

Embodiments of the method disclosed herein perform separation of specular reflections and diffracted seismic energy accomplished for specific source-array geometries using beam MRA depression angles that are significantly different from those corresponding to the specular reflection geometry. The exact MRA depression angle values depend upon the array design and the frequencies present that together determine the response pattern in the vertical plane. From a reference frame centered on the propagating energy ray vector and wavefront, the dependence on separation of diffraction and specular reflection energies depends upon the geometries between the volumetric phased array, the depth of the geologic strata, the characteristics of the Fresnel volume at the interfaces of the strata, and the resulting source-reflection point-receiver geometries.

Furthermore, when multicomponent geophones are emplaced for the array elements, the disclosed embodiments of the method allow separation of compressional wave specular reflections (stimulated using a compressional wave source) from shear wave reflections converted within the Fresnel volume, by way of specifying the beam MRA depression angle and measured phase velocity. Likewise using data input from the same multi-component compact volumetric phased array for acquisition, including shear wave seismic sources makes possible separation of shear wave specular reflections (stimulated using a shear wave source) from converted compressional wave reflections based on beam MRA depression angle and measured phase velocity. Likewise, using the same input data source, the system is capable of suppressing energies selectively, to produce selective images representative of the geological structure and reservoir state. In addition, using standard phased array processing techniques, a null can be steered selectively suppressing the depression angle and phase velocity of the specular reflection beam MRA to remove the strong reflections, allowing the weaker diffractions selectively emphasized in the beam to be used in constructing an image, which is then used alone or combined with the specular reflection image.

Before describing in detail particular methods related to embodiments of the invention, it is noted that the present invention includes a novel and non-obvious combination of process steps comprising the method and implemented as sets of computer instructions to accomplish the desired results. So as not to obscure the disclosure with details that will be readily apparent to those skilled in the art, certain conventional components and steps have been omitted or presented with lesser detail, while the drawings and the specification describe in greater detail other elements and steps pertinent to understanding the invention. Further, the described example embodiments do not define limits as to structure or method according to the invention, but only provide examples which include features that are permissive rather than mandatory and illustrative rather than exhaustive.

Referring to FIG. 2, an exemplary embodiment of a seismic data acquisition and processing system 200 that includes compact volumetric phased arrays 206 and supplies data to an Automated Real Time Microseismic Processing System 214 and a Seismic Survey Processing System 216 that implements the methods of the invention. An Array System comprised of one or more compact volumetric phased arrays 206 of geophones supplies data to the automated real time microseismic processing system 214 and the Seismic Survey Processing System 216. The Array System is customized for monitoring a chosen site based on the geological and geophysical environment, and within physical constraints imposed by the site to satisfy both near real time monitoring and Seismic Survey Processing System 216 analysis purposes. In this example, the dedicated DAQ storage 212, which includes hardware for storing the acquired seismic data, is connected over a network connection to provide long-term data storage and management.

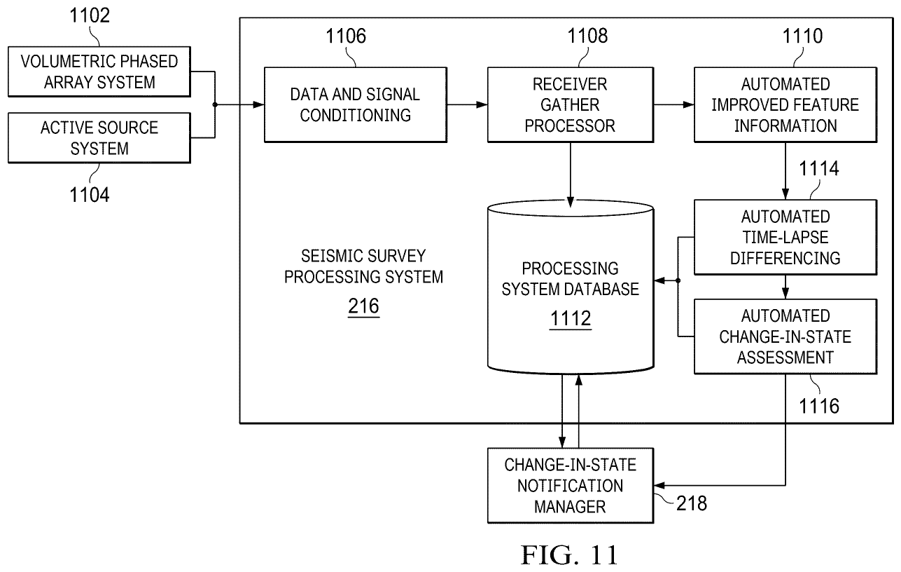

FIG. 11 is a block diagram of an example of the Seismic Survey Processing System 216. The embodiment of the Seismic Survey Processing System 216 shown in FIG. 11 includes a Data and Signal Conditioning block 1106, a Receiver Gather Processor block 1108, an Automated Receiver Gather Image block 1110, a Processing System Database 1112, an Automated Time-Lapse Differencing block 1114, and an Automated Change-in-state Assessment block 1116. In FIG. 11, the volumetric phased array system 1102 represents the compact volumetric phased arrays 206, and the active source system 1104 represents the seismic source 202. A seismic survey is designed with the active source system 1104 in mind to provide phased array data relevant to characterization, monitoring, and imaging specific geologic volumes, and that data are processed in a computational system implementing the Seismic Survey Processing System 216. The standard requirements for data acquisition electronics used in seismic surveys applies to the Array System 1102 including providing time stamped continuously sampled data for each channel, where the time assigned to each sample is tightly controlled (e.g., at least to the 1E−6 second precision level).

In FIG. 11, the functionality of the Seismic Survey Processing System 216 is shown according to data flow as operational blocks (e.g., of automated computer instructions) for processing the system inputs from the volumetric phased array system 1102 combined with the inputs from the active source system 1104. The Data and Signal Conditioning block 1106 regularizes and conditions the input data. The Receiver Gather Processor block 1108 processes the data output by the Data and Signal Conditioning block 1106 as a receiver gather using any of the coherent processing techniques discussed herein, and the output of the Receiver Gather Processor block 1108 is stored in the processing system database 1112. The Automated Receiver Gather Image block 1110 processes the output of the Receiver Gather Processor block 1108 to form an improved automated receiver gather. The Automated Time-Lapse Differencing block 1114 automatically processes the receiver gather image generated by the Automated Receiver Gather Image block 1110 in conjunction with previously processed and stored receiver gather data to form a time-lapse difference, which is another image but contains differences indicative of changes in state. The Automated Change-in-state Assessment block 1116 applies automated pattern analysis algorithms that operate on defined zones of the time-lapse difference images to identify and assess changes in state of the geologic structures of greatest interest, and forward that to a change in state notification manager 218 that packages information into discrete objects and control issuance of notifications or alerts. Note that the order of operations may differ in the detailed flow depending upon which of the imaging methods described herein are chosen.

In the illustrated embodiments, as shown for example in Error! Reference source not found. and Error! Reference source not found., the Array System measures the signals and logs the acquired data with all required metadata about timing, array element position, and channel specific hardware and orientation details, and provides those data as input to the Seismic Survey Processing System 216. The Active Source System is a parallel system that provides a record of the seismic source position, timing, and operating parameters required as input in examples of the system and method disclosed herein in computer readable media. That is to say, each of the primary hardware-software independent system components needed to perform an active source seismic survey supply the required items for the processing system that conform to the requirements for data form and format set in the system interface control document.

The design of the Array System 1102, along with the architecture of hardware and software components within the Offline Seismic Survey Processing System 216 allows for scalable array networks where the basic unit is the Array System 1102 comprised of the volumetric phased array and the array data acquisition subsystem 208, such that addition units of the Array System 1102 require scaling up the computational platforms associated with the seismic survey processing system in known quantified units of equipment and software systems. The system computational hardware is determined based on loading of the required processing and may be centralized to a single processing center. The single processing center may be on site or at a remote location with network connectivity. However, the architecture is flexible enough that multiple processing centers on site may be accommodated for monitoring systems having large numbers of arrays, and such systems will then have networked connectivity to a centrally located operations control center where outputs, results, notifications, and alerts are fused. This hardware architecture is similar to that presented in the included U.S. Pat. No. 12,117,576. The computational hardware components required for the Offline Seismic Survey Processing System 216 are equivalent to the Arrays Server Subsystem 18 in that system, and separate instances of the Processor System 216 software are executed per Array System 1102 (see following software system architecture). It is expected that the Array System 1102 includes data acquisition subsystems with dedicated data storage servers. However, sufficient storage for the acquired active-source survey data, intermediate processing results, and the final processing results and derived information in an organized database, and for an extended time period is a system requirement. The current approach for computational functionality uses dedicated platforms such as standard servers. It is envisioned that similar functionality may be substantiated within cloud storage and cloud computing resources, and with virtual machines running the relevant operating systems for the processing functions, with very little difference to the actual Offline Seismic Survey Processing System 216 and system architecture.

The software system architecture may be based on a modular hierarchy of components that may be joined in combinations of serial or parallel arrangements to efficiently monitor for activity that meets criteria for providing an automated notification. The software system architecture allows for the simultaneous parallel processing of data acquired from any number of Array Systems 1102. This software architecture is similar to that presented in the included U.S. Pat. No. 12,117,576, except it is customized for the active source survey data analysis and follow-on automated time-lapse analysis. In particular, the software architecture allows independent processing for selected Array Systems 1102 using separate instantiations of the Offline Seismic Survey Processing System 216, one per array, in a containerized deployment strategy. For the Offline Seismic Survey Processing System 216, the processing as illustrated in Error! Reference source not found., comprises a series of serial and parallel stages where each stage builds upon the signal and information derived from previous processing stages. Various other combinations of serial and parallel processing will be apparent to persons of ordinary skill. The graphical user interface software for system control or for display of processing results, including comparison with historical information and results, may be based on a client/server architecture.

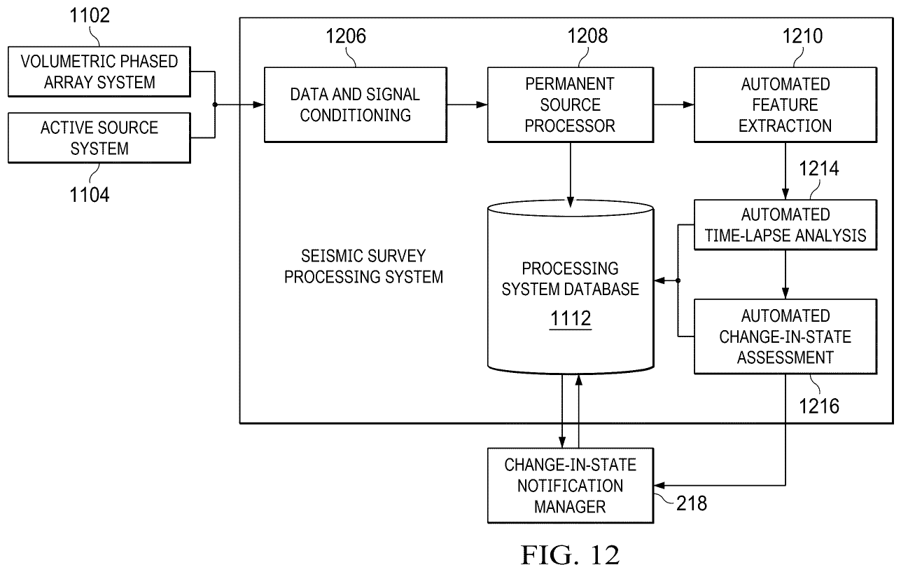

FIG. 12 is a block diagram of an example of the Seismic Survey Processing System 216 configured for permanent active source acquisition. The embodiment of the Seismic Survey Processing System 216 shown in FIG. 12 includes a Data and Signal Conditioning block 1206, the Processing System Database 1112, the Automated Change-in-state Assessment block 1216, a permanent source processor 1208, an automated feature extraction block 1210, and an automated time-lapse analysis block 1214. The processing provided for permanent source system variants may be different from the processing provided by the Seismic Survey Processing System 216 illustrated in FIG. 11. In particular the processing includes extra quality control steps and a “vertical stack” prior to beamforming within the Data and Signal Conditioning block 1206, and automated feature extraction processes of automated feature extraction block 1210 which are different for the single beam time series. The automated feature extraction block 1210 generates a suite of measurements in the time domain, frequency domain, or joint time-frequency domain that can be compared in a time-lapse fashion. The feature extraction process may include other projections such as cepstral processing that are not explicitly considered as included in the aforementioned domains. Extracted features are stored in the processing system database 1112. The automated time-lapse analysis block 1214 provides analysis based on comparison of the features extracted from the single beamformed trace in the automated feature extraction block 1210 thereafter compared as a time series measurement with previous stored results using standard methods applicable to analysis of random processes. For example, control chart methods may be applied to compare a measurement historical data to help distinguish between random variation within model predictions and non-random variation representing measurement result outside of model based acceptable limits. Based on the results from the automated time-lapse analysis block 1214, the automated change-in-state assessment block 1216 performs an automated change-in-state assessment upon the current feature vectors, and upon attainment of measures of confidence a notification of change-in-state outside of expected limits may be issued by the notification manager 218. Note that the order of operations may differ in the detailed flow depending upon which of the imaging methods described herein are chosen.

When all data inputs are present in the system, the processing begins. The initiation of processing may be performed by an operator. However, in some embodiments the Seismic Survey Processing System 216 may periodically check for the presence of all inputs, and automatically initiate processing. Variants that include a permanent source system may be completely automated to initiate processing of the data acquired using the permanent volumetric phased arrays through the assessment of a change-in-state, and notification of results or an alert may be issued in near real time.

Nevertheless, the initial processing to generate a baseline image may be performed primarily by an analyst to ensure the correct configurations are chosen for the individual steps that will then be replicated in the automated systems. Once those workflow configurations and software parameters are set per processing step and stored in the system database, processing of following seismic surveys is automated by repeating the defined workflow using the stored configuration and parameters with the data and signal preconditioning to ensure equivalent measurement input in both spatial and frequency domains.

### Regularization/Normalization

In a preliminary initial processing step, for use with data acquired using a moveable source, a planned and repeatable source positioning, and a planned and repeatable source-array geometry, in conjunction with one or more permanently emplaced Array System(s) 1102, the method operates on the input data volume and the input acquisition geometry. This step is required for the majority of surveys using traditional seismic survey plans, but not needed for embodiments using only repeated measurements with a permanent seismic source and permanent array.

The acquired data geometry may be regularized/normalized to a fixed “grid” of reflection points to take advantage of specular reflection geometries and then beam geometries that acquire energy at MRA angles other than specular. Regularization is accomplished primarily by interpolation to the defined grid. Subsequent surveys use the grid defined in the first iteration of the processing. Regularizing to a fixed grid is a data conditioning step, but not considered as a signal processing step.

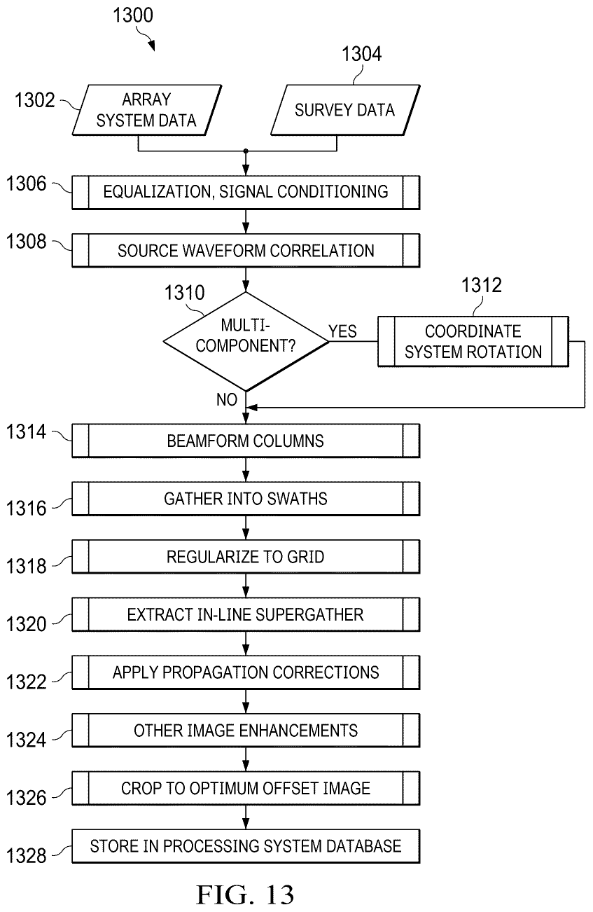

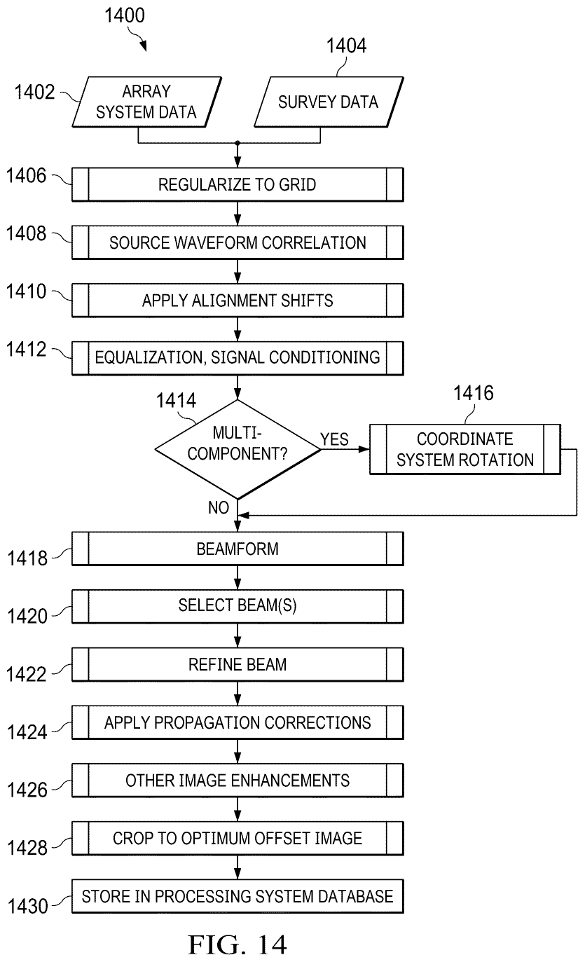

The order of this data conditioning operation may differ in the detailed flows depending upon which of the imaging methods described herein are chosen. For the general descriptions in FIG. 11 and FIG. 12, the regularization step is included in the Data and Signal Conditioning blocks 1106 and 1206. For the detailed flow of the VPA supergather method in FIG. 13, the regularization step is included in block 1318, and for the detailed flow of the beamforming method of FIG. 14 the regularization step is included as an initial step in block 1406.

### Equalization and Signal Conditioning

Also, in an initial step, the method operates on data frames to perform an equalization and signal conditioning operation, to ensure the geophones occupying the phased array elements produce equal outputs for equal inputs. For the general descriptions in FIG. 11 and FIG. 12, the equalization and signal conditioning step is included in the Data and Signal Conditioning blocks 1106 and 1206. For the detailed flow of the VPA supergather method in FIG. 13, the equalization and signal conditioning step is included in block 1306, and for the detailed flow of the beamforming method of FIG. 14 it is included as an initial step in block 1412.

The operation can take a variety of forms and may range from a simple scalar gain factor applied to each recorded time series, to providing a transfer function that equalizes frequencies across the geophone spectral response without allowing phase distortion. The latter equalization technique is generally known as zero forcing equalization, see Mark, W. J., and W. Zhuang, Wireless Communications and Networking (2003), not to be confused with zero forcing beamforming explained above. In the zero forcing technique, originally applied in the field of wireless communications, the output of each array element is corrected for the assumed “channel” response. Channel in this case refers to the output of the sensor and includes differences in the physical sensor response as well as distortions from the propagation path. For this application we first identify the output from the most stable array element, derived from an application of the array calibration method of Langston (2018), as the desired response See Langston, C. A. (2018). Calibrating Dense Spatial Arrays for Amplitude Statics and Orientation Errors, J. Geophys. Res. (2018). Then an equalization technique is applied, e.g., the mentioned zero forcing equalization method. The equalized outputs then are the input to all following operations. This step may also be lumped along with other “signal conditioning” operations designed to edit out malfunctioning channels, modify any clipped signal segments, filter the working frequency band into sub-bands, and generally ensure the data quality.

In some cases, signal conditioning can include frequency-wavenumber (FK) filtering. Normally, FK filtering is performed based on the apparent velocity projection into an apparent wavenumber across a two-dimensional spread of geophones. For the data delivered by the compact volumetric phased array 206 and acquisition system 208, the true wavenumber is used to define a more precise, physics-based filter or mute in a receiver gather domain for individual shots points.

For the permanent source pedestal mounted systems 602, signals acquired by the compact volumetric phased arrays 206 and 608 from individual, repeated permanent source shots are conditioned for quality and frequency content in the data and signal conditioning block 1206. This conditioning includes an editing function to remove data records containing weak shots, misfired shots, or shots with timing errors from use, and then the final conditioned set are stacked per array element based on shot zero-time to enhance the signal-to-noise ratio (SNR).

### Volumetric Phased Array Supergather

In seismic signal processing, the initial processing of the recorded time series with the goal of creating an image of the subsurface attempts to remove the effects of the seismic source signature and propagation path in order to return a time series more closely resembling the reflectivity series of the earth applying steps such as cross-correlation, deconvolution, and gain. For survey data originating with a frequency-controlled seismic source (e.g., source 202), the data are cross correlated with the source waveform. This procedure is sometimes called replica correlation or pulse compression. Correlating with the source waveform collapses the spread spectrum energy into an ambiguity function for specular reflectors, and is a common procedure.

Velocity and statics analysis coupled with moveout corrections and/or migration are also part of a standard seismic processing sequence. These signal processing techniques correct for propagation effects and optimally align and position recorded seismic signals to image the corresponding subsurface reflectors. The goal is to continuously image the geological strata, and to create well defined and correct representations of the geologic structures. The velocity and statics analysis is usually performed on individual surveys.

Compact volumetric phased arrays 206 may be deployed as in spatially-sparse networks, for example, rather than as carpets of sensors as in a conventional three dimensional acquisition survey. Given the geometry, common receiver gathers rather than common shot gathers are more natural to display the data. Surface shot locations will be more important to determine the subsurface illumination cone. A two dimensional shot line will be narrowly “three dimensional” given the crossline aperture of the volumetric array. Such narrow three dimensional “swath” subsurface volumes are sometimes termed 2.5D (two and ½ dimensional characterization of the geology, i.e., not true three-dimensional geologic characterization). The 2.5D swaths are supergroups of the point sensor receiver gathers from the volumetric array. This achieves a high spatial resolution from the tight point receiver spacing within the array aperture if array group forming is not performed, which is a trade-off with noise cancellation. See, e.g., Ourabah, 2024, Revisiting the Single Sensor vs. Array Debate in the Light of New Nodal System Technology, First Break (2024). Of course, in a volumetric array, point sensors can be group-formed or stacked in the vertical dimension without diminishing the lateral spatial resolution, which is accomplished for example by a static time shift alignment prior to stacking.

Such “VPA supergather” swaths can be assembled from single component or multicomponent time series. If the array aperture is more than at least equal to 80% of the survey shot spacing, the resulting midpoint spacing within the swath will become based on ½ the point receiver spacing rather than ½ the shot spacing as with a conventional array-formed receiver gather group. For most conventional source geometries this will provide finer spatial sampling. Depending on the array and source geometries, this may introduce an irregular (i.e. —non-gridded) geometry to the midpoint locations within the super-gather swath, but this can be regularized with interpolation as described above. The array aperture must be greater than at least 80% of the shot spacing in order to avoid introducing gaps in the midpoint coverage between consecutive shots.

FIG. 13 is a flowchart of an example method 1300 of generating a VPA supergather from a standard two dimensional survey line. Though depicted sequentially as a matter of convenience, at least some of the operations shown can be performed in a different order and/or performed in parallel. Additionally, some implementations may perform only some of the operations shown. The method 1300 assumes an array design approximating a uniform cylindrical distribution of geophones (a uniform cylindrical array). Operations of the method 1300 may be performed by the Seismic Survey Processing System 216. In block 1302, the Seismic Survey Processing System 216 receives point sensor time-series data from the compact volumetric phased array system covering the duration of a seismic survey. In block 1304, the Seismic Survey Processing System 216 receives seismic survey specification data (the survey plan as executed) containing the sequence of shot point timing and location for either a survey source line (linear survey) designed for producing a two-dimensional seismic profile or the survey source two-dimensional sampling area designed to illuminate a specific geologic volume.

In block 1306, the Seismic Survey Processing System 216 applies equalization and signal conditioning, separately for each component of multicomponent data.

In block 1308, the Seismic Survey Processing System 216 correlates the data generated in block 1306 with source waveform (if applicable).

In block 1310, the Seismic Survey Processing System 216 determines whether the data being processed includes multiple components (e.g., x, y, and z components). If the data is multicomponent, then, in block 1312, the Seismic Survey Processing System 216 rotates initial sensor coordinate system orientation of the multi-component data into the proper coordinate systems corresponding to the inline, crossline, and vertical components.

In block 1314, the Seismic Survey Processing System 216 beamforms the spatially co-located vertical columns of sensors using a static time shift for alignment, providing a specific aperture and vertical sensor spacings meet requirements relative to wavelengths and differences in arrival times to generate a single wide angle beam per sensor column.

In block 1316, the Seismic Survey Processing System 216 combines all point sensors (or subsets of point sensors) for sets of shot lines and collect as “gathers” of swaths, the swath being the cloud of reflection points for specular reflections in a surface approximating the geologic structures of greatest interest.

In block 1318, the Seismic Survey Processing System 216, regularizes to a gridded geometry by interpolating within the dimensions of the swath.

In block 1320, the Seismic Survey Processing System 216 extracts the inline receiver super-gather from the center line of the swath for a 2D line (or keep 3D geometry as a “sub”-cube volume); the crossline aperture of the swath is limited by the diameter (horizontal aperture) of the array.

In block 1322, the Seismic Survey Processing System 216 applies normal moveout (NMO) corrections, or alternately apples a seismic migration operation, to the traces in the receiver supergather to correct for propagation delay.

In block 1324, the Seismic Survey Processing System 216 may apply additional image enhancement techniques.

In block 1326, the Seismic Survey Processing System 216 assembles the image with appropriate processing that reveals the optimum-offset range of clean data imaged outside the ground roll and air wave noise cone, and crops to a predetermined optimum-offset lateral extent.

In block 1328, the Seismic Survey Processing System 216 stores the image in the processing system database 1112. The processing system database may store processed seismic signals, images, processing system configuration information, image difference information, and change-in-state information.

The VPA supergather swath method provides a higher spatial resolution image that is less prone to spatial aliasing than treating the compact volumetric phased array as a single receiver group and summing all the channels to create a single averaged response. However, the supergather approach does not take full advantage of the phased array design and, outside of the single column beamforming, will not generate highest SNR gains that full array beamforming methods produce. Additional approaches based on digital array group forming on subsets of VPA supergather swaths may be applied following similar general procedures as described here.

### Beamformed Image

Beamforming takes advantage of the coherence of a signal originating from a common source and received across the array, and the simultaneous independence of the ambient noise field across that array. In this regard, beamforming spatially averages phase differences in signal data received by the individual phased array elements to emphasize signals that are temporally in-phase across the array at specific angles of arrival and phase velocities. In doing so, additive beamforming maximizes the SNR for marginal SNR signals compared to the individual channels and provides a filtering of interfering coherent signals with wavenumbers not aligned with the beam MRA.

The seismic data acquisition and processing system 200 provides automation of the process that generates a subsurface image, and the processing of following surveys, to then enable the automation of the time lapse analysis. In this sense, the generation of the initial image constitutes a supervised machine-learning function for defining the parameters and configurations used in the processing flow required to produce the desired result, which are then saved in a system database. For processing of following surveys using identical acquisition plans, the parameters and configurations are applied to the data in the automated workflow for the comparison of the resulting differences in images or, in the case of using permanent sources. In this sense, applying beamforming operations as a key step in automatically generating the images is an ideal approach as amenable to automation with repeatable results.

The initial step in the beamforming method accepts conditioned data, and applies beamforming-signal processing operations that combine the individual channels to emphasize the spatial coherency of the data streams. The term “Spatial” used in this descriptor distinguishes the disclosed technique from other methods designed to take advantage of the coherencies of sinusoidal signals strictly in time (in frequency) without any spatial considerations. The beamformer discussed here assumes plane waves arriving at the array, and sensors spaced such that the coherence between the signals of interest as seen on the separate sensors is very high, while the coherence in the noise is minimal. In advantageous embodiments, the beamforming result increases the power of the measured signal and decreases random noise in the data as well as coherent clutter arriving at the array from directions other than that aligned along beam MRAs. The automated beamforming operation create multiple discrete “beams” corresponding to specified angles of arrival and the measured actual phase velocity value for the received wave front.

The automated beamforming process includes defining a set of angles with respect to the array reference point and a set of propagation velocities applicable to the media within the array aperture, and then processing the data from all array elements such that for each defined angle (azimuth and depression angle) and phase velocity in the set, the plane waves arriving at the array along that specified angle and propagation velocity are emphasized via coherent processing. The defined beams represent beams that are targeted to depth points in the geologic structure to include primarily specular reflections, but also on a secondary set diffractions.

In an example general delay and sum beamformer, the following operations are executed in computer instructions:
Receives data from the processor after data and signal conditioning.
Reads configuration information stored in memory or from a database pertaining to the desired beam geometries.
Transforms data frames from each sensor into the frequency domain using the Discrete Fourier transform. However, other approaches such as the Cosine Transform are also applicable. The result is the frequency domain projection of the time series as complex-valued frequency-domain coefficients.
Multiplies the vectors of complex valued frequency-domain coefficients by the precalculated phase delays implemented in slowness space. The result is a set of complex numbers in the frequency domain, as a function of the three components of slowness space.
Sums the results as frequency domain frames that are the equivalent of a time-domain delay-sum operation. The magnitudes of these numbers squared are the sensed coherent power at that frequency, for each beam.
The resulting beamformed data is transformed back into time domain and output to either a stream interfaced to another processing component, computer memory, or a file for following processing steps.

Furthermore, features of the method are, in part, based on recognition that an array with a small element spacing d compared to the signal wavelength and having a small aperture, when receiving multiple signals along multiple angles of arrival can only effectively process the most energetic signal at a given frequency and/or will result in a weighted average estimation of the angle of arrival. With a small aperture array, there would be little or no possibility of separately resolving the bearing angle of a single one of multiple sources when received simultaneously with signals from one or multiple other sources having the same frequency content. The fact that the ambient background noise is not independent across channels at these wavelengths due to the close proximity of the sensors also means that no advantage in improved SNR is had by adding additional sensors to the small aperture array (or for arrays where d is small compared to wavelength, e.g., for d<25% of λ. Also true is that an array with inter-element spacings d much greater than the wavelength of a signal of interest results in a spatially aliased measurement.

An objective of the beamforming operation is a determination of an angle of arrival (AOA) for a signal of interest (SOI) based, in part, on the coherence of signals acquired from multiple array elements within the common sensor array. The beamforming operation applied within the disclosed method creates a large number of discrete “beams” each of whose main response axis (MRA) corresponds to specified angles for azimuth and depression angle with respect to a spherical coordinate system referenced to a fiducial location within the array and a specified slowness (reciprocal velocity) value representing a measured phase velocity across the phased array. The number of unique beam MRAs and the MRA specifications (azimuth, depression angle, phase velocity) are all specified in configuration files. A general practice common in the field is to construct the suite of beam MRAs such that the response at a particular frequency overlaps between them at the 3 dB down points.

The beams comprised of time-series values are derived from the continuous signals acquired using the independent array elements, each beam aligned along an axis extending from the fiducial reference location along a potential angle of arrival of seismic plane waves. For an embodiment that includes active source survey signals, the time-series frame duration may extend up to the record length for each shot, or the entire received shot record may be subdivided into short duration frames that are reassembled into the overall beam time series. Mathematical details of an example beamforming procedure are addressed in the prior Beamforming discussion equations (1) through (24).

Each beam is defined with a unique MRA specified with parameters azimuth angle, depression angle, and slowness value. In one embodiment, the seismic signal inputs for each data frame are phase shifted in the frequency domain to values that align the signals with a hypothetical wavefront arriving along the specified beam axis. The phase shift is determined corresponding to a time shift calculation of the delay of a plane wave arriving along the specified azimuth angle and dip angle for the specified slowness for the spatially distributed array elements. A summed signal value is associated with each set of beam parameters.

The beamforming output, consisting of the complete set of summed values for each set of azimuth angle, depression angle, and slowness s=1/c, for the current data frame is then saved to computer memory for follow on processing. In aligning to preferentially favor signals arriving along the beam MRA, the beamforming operation acts as a spatial filter (i.e., wavenumber filter) for a particular “look-direction” and velocity.

Because the compact volumetric phased arrays are emplaced in a fully elastic medium, as opposed to an acoustic medium, the received seismic waves consist of superimposed compressional waves, shear waves, and Rayleigh waves. In an embodiment of the method, the automated beamformer is implemented using multiple phase velocities as measured across the compact volumetric phased array to take advantage of the compressional, shear, and Rayleigh waves different propagation velocities. All of these waves propagate to and across the array and are sensed by the array elements, occupied by either single- or multi-component geophones, enabling direct measurement of the angle of arrival, the phase velocity, and quantities related to gradients.

Beamforming hypothesizes the direction which the plane wave is received propagating from a reflection, refraction, or diffraction point to the geometric center point of the sensor array. The series of discrete beams then are constructed using as input the continuous signals acquired by the array elements, where each beam is aligned along an axis Bi extending between the reference point of the sensor array along the angle of arrival (AOA) of seismic plane waves, specified as azimuth angle Φᵢ (see FIG. 4) and depression angle θᵢ with respect to a spherical coordinate system referenced to a fiducial point within the array, and the measured phase velocity.

Using the Array System 206 for data acquisition enables measuring the true propagation velocity across the array. Hence, processing of signals received by geophones in the compact volumetric phased array 206 then exploits the measured propagation phase velocity and then independently measures the angle of arrival enabling a more complete characterization than is possible with planar or linear arrays. With an appropriately designed array and automated beamforming processing, embodiments of the invention may be applied to separate energy arriving from different directions and of overlapping frequencies that are simultaneously received. Furthermore, when the volumetric phased array includes multicomponent elements, the separation of horizontally polarized shear (crossline direction), vertically polarized shear (sagittal direction), and compressional (inline direction) vibrational modes using beamforming approaches is enabled.

A number of differing beamforming techniques have been developed to take advantage of phased array provided data. The most basic techniques use variations of the delay-and-sum approach applied either in the time domain or frequency domain to shift and align signals in time or phase according to time of arrival delays computed from the spatial relationships between the array elements. More advanced techniques adapt beamforming parameters to maximize the received signal and minimize noise or interference. These techniques usually require the derivation of the beamforming algorithm parameters from some statistics derived from the recorded data. Some examples of these adaptive approaches are the minimum-variance-distortionless-response, the Frequency-Wavenumber “best beam” approach, the Multiple Signal Classification, or MUSIC, algorithm that decomposes the covariance matrix into a signal and noise parts, and maximum likelihood (ML) parametric beamformers. The method disclosed herein adopts beamforming techniques for a compact volumetric phased array emplaced within the earth and receiving energy propagated as elastic waveforms. However, any beamformer that may be used to create multiple beams with planned, known MRAs are acceptable for use in embodiments of the method.

In addition, for embodiments designed around permanently emplaced sources, automated beamforming of the array provides a single beam targeted on the reflection point on the horizon of interest, or a suite of beams targeted on individual geologic volumes of interest, or targeted on other subsurface geologic structures that may be used as control points for determining a change in state. The single-beam time-series become the basis for time-lapse analysis for determining a change in state.

By way of example, beams corresponding to multiple potential directions of arrival in three-dimensional space, are generated for particular values of phase velocity, azimuth angle Φ, and dip angle θ, where the latter two are defined in FIG. 4 for a spherical coordinate system. The pointing direction for any beam is specified according to a main response axis (MRA) as a function of (φ, θ, c). Alternately, the phase velocity c can be expressed instead as a slowness, which is the reciprocal of the phase velocity, i.e.,

$$( \frac{1}{c} ) .$$

Each beam additively collects the seismic signals impinging upon the array with plane-wave fronts perpendicular to the specified beam MRA, and acts as a spatial filter to suppress non-coherent noise and clutter, and coherent signals arriving from other directions, as illustrated for example in FIG. 10.

For the purpose of characterizing and imaging one or more geologic structures, generally resource reservoirs or source rocks, or confining structures, beam MRAs are chosen targeting a depth point (a target depth point), i.e., the reservoir or caprock horizon is targeted and the beam parameters are determined in view of a velocity model of the geologic stratigraphic section. This is part of the planning process usually accomplished before data acquisition.

FIG. 14 is a flowchart of an example method 1400 of targeted automated beamforming for producing an enhanced receiver gather using seismic survey data provided by a compact volumetric phased array 206. Though depicted sequentially as a matter of convenience, at least some of the operations shown can be performed in a different order and/or performed in parallel. Additionally, some implementations may perform only some of the operations shown. Operations of the method 1400 may be performed by the Seismic Survey Processing System 216. In block 1402, the Seismic Survey Processing System 216 receives point sensor time-series data from the compact volumetric phased array system covering the duration of a seismic survey. In block 1404, the Seismic Survey Processing System 216 receives seismic survey specification data containing the sequence of shot point information of either a line or covering an area to illuminate a specific geologic volume.

In block 1406, the Seismic Survey Processing System 216 regularizes the data grid to a canonical specular reflection point grid.

In block 1408, the Seismic Survey Processing System 216 correlates the regularized data produced in block 1406 with the source waveform (if applicable).

In block 1410, the Seismic Survey Processing System 216 determines and applies alignment static shifts according to defined windows as a function of source-receiver offset, executed for time-lapse acquired data, executed iteratively until difference metrics are below a set threshold.

In block 1412, the Seismic Survey Processing System 216 applies equalization and signal conditioning, separately for each array element and component of multicomponent data. For example, the Seismic Survey Processing System 216 can automatically apply equalization of detected signal strength among like channels in an array.

In block 1414, the Seismic Survey Processing System 216 determines whether the data being processed includes multiple components (e.g., x, y, and z components or equivalents). If the data is multicomponent, then, in block 1416, the Seismic Survey Processing System 216 rotates initial coordinate system of the multi-component data into the proper coordinate systems corresponding to the MRAs for the desired beams (in line with the MRA, crossline to the MRA, and sagittal being perpendicular to the MRA and in the vertical plane defined by the source and reflection point).

In block 1418, the Seismic Survey Processing System 216 beamforms the multi-channel input resulting in generation of time series for the suite of defined beams with fixed MRA, The Seismic Survey Processing System 216 performs the automated beamforming operation for each component of multicomponent array elements. For example, the Seismic Survey Processing System 216 may automatically beamform to a target depth point to provide a receiver gather image representing the geologic structure within a selected offset range.

In block 1420, the Seismic Survey Processing System 216 determines the MRAs of the beams containing the desired signals.

In block 1422, the Seismic Survey Processing System 216 refines the azimuth, dip, and phase velocity for the desired signals; creating refined beams for the desired signals.

In block 1424, the Seismic Survey Processing System 216 applies normal moveout (NMO) corrections across the traces in the receiver gather to correct for differential propagation delays.

In block 1426, the Seismic Survey Processing System 216 applies additional image enhancement techniques (e.g., image enhancement techniques known in the art).

In block 1428, the Seismic Survey Processing System 216 assembles the image from like processed records from multiple shot points with appropriate processing that reveals the optimal-offset range of clean data, and crops to a predetermined configured optimum-offset lateral extent.

In block 1430, the Seismic Survey Processing System 216 stores the image in the processing system database 1112.

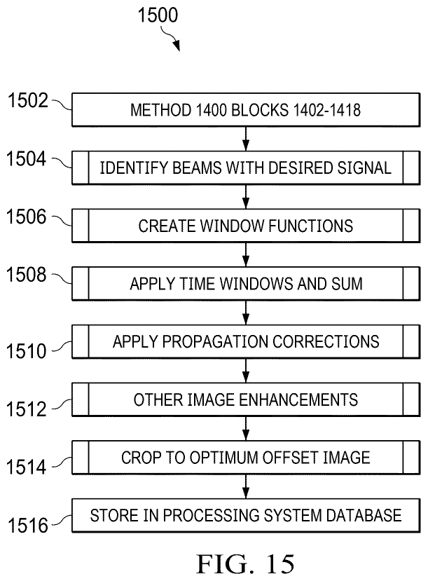

Beamforming may be performed according to the method 1400, or in some examples, beamforming may instead be modified to create a composite beam. FIG. 15 is a flowchart of an example method 1500 of targeted automated beamforming for producing an enhanced receiver gather including a composite beam. Though depicted sequentially as a matter of convenience, at least some of the operations shown can be performed in a different order and/or performed in parallel. Additionally, some implementations may perform only some of the operations shown. Operations of the method 1500 may be performed by the Seismic Survey Processing System 216. The method 1500 may highlight multiple signals, or emphasize multipath arrivals for a single signal.

In block 1502, the Seismic Survey Processing System 216 performs the operations of blocks 1402-1418 of the method 1400.

In block 1504, the Seismic Survey Processing System 216 determines the MRAs of the beams containing the desired signals.

In block 1506, the Seismic Survey Processing System 216 determines times of arrival of the desired signals in the identified beams and creates mathematical windows to highlight those sections and suppress the time spans not containing the signals of interest. The time specific window functions may be any of those providing a tapered transition such as, for example, Gaussian, Parzen, Hann, Blackman, Nutall, Tukey, Kaiser, Dolph-Chebyshev windows. The windows should be constructed to overlap such that for any point in time the sum total weight of functions applied to the multiple fixed MRA beams is (1). The possible window functions are not limited to these examples.

In block 1508, the Seismic Survey Processing System 216 applies the time windows to the identified beams and performs a summation of the identified beams to create a composite beamed time series.

In block 1510, the Seismic Survey Processing System 216 applies propagation delay corrections across the traces in the receiver gather, and additional image enhancement techniques.

In block 1512, the Seismic Survey Processing System 216 applies additional image enhancement techniques.

In block 1514, the Seismic Survey Processing System 216 assembles the image from like processed records from multiple shot points with appropriate processing that reveals the optimal-offset range of clean data, and crops to a predetermined configured optimum-offset lateral extent.

In block 1516, the Seismic Survey Processing System 216 stores the image in the processing system database 1112.

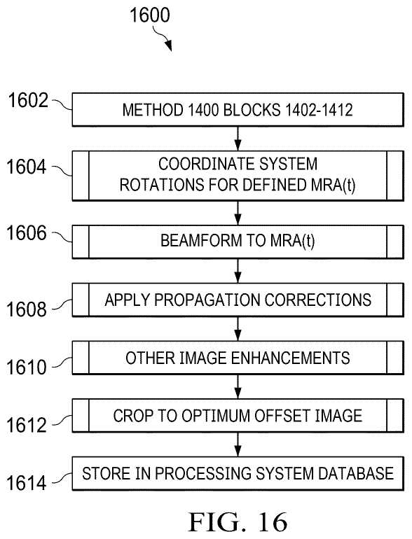

FIG. 16 is a flowchart of an example method 1600 of targeted automated beamforming for producing an enhanced receiver gather comprised of dynamically steered beams, where the beam MRA changes according to a predefined function of time. Though depicted sequentially as a matter of convenience, at least some of the operations shown can be performed in a different order and/or performed in parallel. Additionally, some implementations may perform only some of the operations shown. Operations of the method 1600 may be performed by the Seismic Survey Processing System 216.

In block 1602, the Seismic Survey Processing System 216 performs the operations of blocks 1402-1412 of the method 1400.

In block 1604, the Seismic Survey Processing System 216, for multicomponent data, generates rotated data for the proper coordinate systems corresponding to the predefined steered beam MRA(s) as a function of time.

In block 1606, the Seismic Survey Processing System 216 automatically beamforms the multi-channel input resulting in generation of time series for one or more beams with predefined MRAs as a function of time, by coherently combining the data acquired from each sensor. The Seismic Survey Processing System 216 performs this operation for each component of multicomponent array elements.

In block 1608, the Seismic Survey Processing System 216 applies propagation delay corrections across the traces in the receiver gather.

In block 1610, the Seismic Survey Processing System 216 applies additional image enhancement techniques.

In block 1612, the Seismic Survey Processing System 216 assembles the image from like processed records from multiple shot points with appropriate processing that reveals the optimal-offset range of clean data, and crops to a predetermined configured optimum-offset lateral extent.

In block 1614, the Seismic Survey Processing System 216 stores the image in the processing system database 1112.

For the dynamically steered beams approach, the emphasis is on providing the maximum SNR for a signal representative of arriving seismic energy where the signals' angle of arrival changes as a function of time, such that the result is dynamically steering the beam MRA as a function of time to best emphasize that signal and separate as much as possible from other signals, to highlight multiple arriving signals as a function of time, or to emphasize multipath arrivals for a single signal.

The composite beam and steered beam approaches may be different for the different components of multicomponent seismic data to align with goals of compressional wave imaging, shear wave imaging, or converted wave identification and imaging. Furthermore, the different schemes for assembling multiple beams, composite beams, or steered beams may be used to focus receiving specular reflections.

For example, the beamformed traces maximize the received signal arriving from specular reflections associated with the reflection points while also providing a basic spatial filtering of ground roll and air wave clutter. The method provides computer instructions that, by processing multiple source-receiver offsets as specified, a composite image is assembled, and the spatial filtering and coherent processing provided by beamforming approach sharpens the image while providing additional useful image information where prior to beamforming the image was obscured by ground roll and air wave clutter. In short, the automated beamforming operation applied to that data supplied by the compact volumetric phased arrays maximizes the SNR of the reflected signal, improving the image resolution, and improving the capability for imaging the desired geologic structure into the noise-dominated cone, thus expanding the optimum offset window.

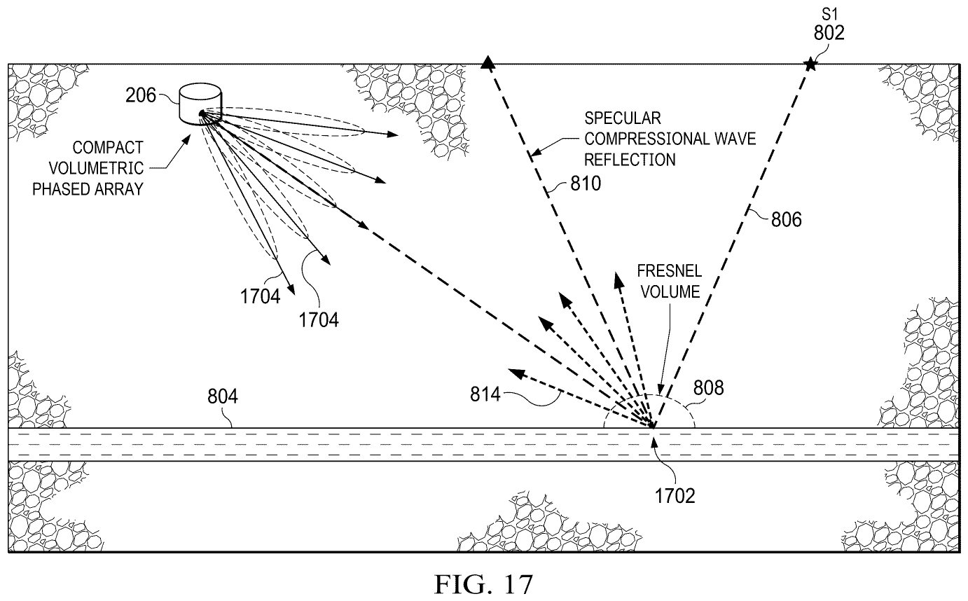

Furthermore, when desired, at least one of the generated beam MRAs is aligned with expected paths of diffracted energy, so as to better capture that energy associated with geologic structure such as faults and fracture zones, as illustrated in Error! Reference source not found. FIG. 17 shows an example two-dimensional vertical slice through an Earth volume containing the seismic source 802, specular reflection raypath 810, reflection point 1702, and receiver array 206 for a single shot geometry from a seismic survey. The specular reflection raypath 810 traces the path of the seismic energy to the reflection point 1702, and then to a point on the surface. An embodiment of the Seismic Survey Processing System 216 can generate many beams of data where the beam main response axis 1704 (radial lines from the receiver array 206 with example main response lobes) in the specified vertical plane of the source, reflection point, and array to capture diffractions.

That energy is then assembled into an image similar to a common receiver gather based on the offset of the source or the midpoint for a specular reflection, and after additional processing typical in the art, the result added to the image produced from specular reflections to generate images with improved detail.

### Performance with Attrition

Embodiments of the system and method described herein provide a robust repeatable imaging capability when using permanently deployed compact volumetric arrays upon the eventual loss or malfunction of one or more array elements. Sensitivity to sensor loss depends on the array design and the relative locations of the functional elements. Beamforming the data acquired using the compact volumetric arrays generates very stable results, meaning that changes in the array or in the earth volume directly adjacent to the array are averaged out of the signal in the resulting beam.

For example, in controlled trials using lightweight vibroseis seismic sources, the targeted beam method constructs a useful geological image with only 50% of the receiver array 206 functioning that is still superior to conventional receiver gathers. This robustness in imaging and beam stability is critical for automatically generating images that can be used for time-lapse monitoring over significant operating times of the geologic reservoir system, that are not particularly sensitive to small perturbations in the image due to noise processes, yet nevertheless resolve actual differences in the image originating with physical changes in the geologic volume being resolved.

### Automating Time-Lapse Measurements

Once a satisfactory processing sequence is determined, the steps are automated such that subsequent seismic surveys using the same geometry are processed in a turnkey fashion given inputs in the same form (a standardized, automated processing sequence). That is to say, the inputs for the system conform to the requirements for data form and format set in the system interface control document. The configurations and parameters for the workflow are read from the stored information in the systems database. All workflow processing elements have been customized to the site-specific geology and geophysical conditions in the initial processing workflow step as well as the monitored geologic volume of interest.

For the variants featuring permanent sources, once the sequence is determined and the baseline feature set generated, the sequence is automated to extract features based on the same source acquisition geometry. The single-beam waveform, or characterization information is then compared to previous images or characterizations in a time-lapse evaluation by differencing waveforms and features to produce information (time-lapse change-in-state information) indicative of time-lapse anomalies or a change-in-state of the subsurface.

High interest zones are interrogated by defining time windows relative to the source time, and using pattern analysis methods to ascertain a change-in-state. Using the permanent source, changes-in-state in the waveform and extracted features of the geologic volume about the reflection point in comparison to base values are monitored at short intervals, for example routine source firing on a daily, weekly, or monthly schedule. In time, changes in amplitude, timing of the peaks, and other extracted features, are reduced to a history of measurements typically displayed as “control charts,” for example. Changes in the amplitude and/or timing of the specific amplitude peaks associated with the depth layer of interest may indicate changes in the monitored geological structures. In addition, the amplitude spectrum is plotted and monitored for changes in any frequency band, themselves treated as measurements of a random variable or process. This assessment may be completely automated such that the assessment of change in state is performed automatically (without operator or analyst intervention), and a change-in-state notification automatically issued, enabling the automated and remotely controlled source activation, data acquisition, analysis and assessment, resulting in the final action of issuing a change in state alert at near-real time latencies.

For standard seismic survey approaches, the standardized processing sequence including grid regularization and trace alignment is repeated to produce images for each subsequent survey. Single survey alignment procedures are applied according to the defined, standardized processing sequence until traces are aligned acceptably within a single image. These are the applied velocity and statics analysis, moveout corrections, and/or migration signal processing techniques that correct for propagation effects aligning the seismic signals to form an image, as performed in the standardized process to form the baseline image, now applied to subsequent repeated surveys to form equivalent time-lapsed images. In other words, the method then generates an equivalent image for the newest monitor survey according to the pre-defined standardized processing configuration.

However, in time-lapse analysis of the seismic images, alignment of images from different surveys (separated by time) is also critical for “registering” the images to determine the differences that indicate actual geologic and geophysical changes. For example, image alignment accounts for near surface changes in the geophysical structure (such as weather related velocity structure changes) from one survey to the next that would account for “bulk-shift” changes between images. Alignment is primarily performed via a cross-correlation between defined blocks in a time- and space-windowed section of the reflection record (image) that includes a strong reflector. That method is referred to in this application as a “blockwise” alignment. The alignment process results in a static shift in time relative to the zero time of the source for the image between equivalent sections of separate active source seismic survey images. The alignment procedures may be applied in an iterative manner until common offset regularized gridded traces are aligned acceptably, according to a maximum threshold measured for differences in the specified windows. An advantage of using the permanent placed arrays is that static shifts originating on the receiver ends should be minimal; the shifts will result primarily from the seismic source interaction with the ground, and the near-surface conditions.

Following the automated processing that results in the new monitor survey image and image alignment, differences between the baseline survey image and the new image are generated. The difference image is the basis for time-lapse analysis. Quality metrics of this difference image are compiled such that an automated assessment of the general time-space blockwise agreement between the two images is produced and tracked. For example, a key quality metric is the normalized root of the mean squared (NRMS) measurement, see Kragh, E. and Christie, P., Seismic repeatability, normalized RMS, and predictability, The Leading Edge (2002), used to set the minimum threshold above which signal differences are considered as measurable time-lapse information. Images, difference images, metadata, and quality metrics are entered into the processing system database 1112.

A time-lapse comparison then may be generated by operating on the images, difference images, and feature sets, to identify changes of state in specified zones using pattern analysis methods. At least one pattern analysis method includes an artificial intelligence component once sufficient training data has been accumulated.

The automated time lapse differencing block 1114, the automated time-lapse analysis block 1214, and automated change-in state assessment blocks 1116 and 1216 shown in FIGS. 11 and 12 detect state changes based on the time-lapse base and updated images and the time-lapse difference image that provides information on the change in state of the reservoir system. The Seismic Survey Processing System 216 analyzes pre-defined blocks in time and offset or depth and offset from the difference image representing control blocks and volumes under test to determine if a change-in-state can be distinguished from random noise differences. The approach is a further step in the processing of time-lapse images to reduce differences in the images to information indicating a change-in-state. Provided a change-in state is indicated, notification is sent to the operators of the field and their automated control systems. The information provided from this monitoring and analysis system is useful in SCADA and DCS systems for assessing operations control decisions. Such decisions may be based on the measurement information provided, or based on measurement-model-offset assessments, for example. The processing results, statistics based on control blocks, and all evidence of the change in state are stored in the processing system database 1112. The Seismic Survey Processing System 216 may automatically initiate the processing described herein to produce the change-in-state notification (e.g., generate an image of a geologic structure, determine difference between images, and provide the change-in-state notification) responsive to acquisition of the seismic signals to be used in generation of an image.

A time-lapse comparison may be generated by differencing operating on the images, difference images, and feature sets, and the difference image operated on to identify changes of state in specified zones using pattern analysis methods. At least one pattern analysis method includes an artificial intelligence component once sufficient training data has been accumulated.

The initial time-lapse automated assessment based on a limited set of time-lapse snapshots may take the form of a statistical hypothesis test, where the starting hypothesis is “no significant change.” A change-in-state then represents a “type 1 error” against that starting hypothesis. The statistical tests generally would follow the methods described as sequential analysis, and in particular change-point detection. Examples include sequential probabilistic ratio tests in general and Page's test in particular. These change point assessments may be applied to the feature sets extracted from the time-lapse images in “control chart” fashion or applied against the difference images directly. Once a significant volume of data is collected over multiple sequential surveys indicating no significant change-in state, and all geophysical structure images and difference images generated, and metrics accumulated, the comparison process may be further automated using an artificial intelligence (AI) process. The AI process is similar in architecture to what has been used in the U.S. Pat. No. 12,117,576 (incorporated herein by reference in its entirety). This AI instantiation takes the form of a binary pattern classifier producing a decision of whether the most recent “receiver gather” image and difference image represents an innovation over the training set, which also may be considered as a “type 1 error” where the null hypothesis is “no difference.” However, where U.S. Pat. No. 12,117,576 focuses only on the received signal from a passive sense and identification of the energy source, the system and method described herein focuses on the subsurface image generated from processing reflections of a signal generated from a known and controlled source, that is then further processed in a time-lapse sense (or differencing sense) to identify changes in the state of specified subsurface volumes.

The training set for the AI process consists of the images generated from all previous collected active surveys with the same source-array geometries, regularized to the same grid, and automatically beamformed to the same depth points. The training of the AI process is analyst driven (not automated) and founded on image processing techniques for identifying anomalies in image sets. For this application then, the AI training method broadly comprises a supervised machine learning approach. Note that several sets of time-lapse processed subsurface images representing different acquisition geometries or processing sequences may be used for training, to provide understanding of the evolution of anomalies, or to quantify the sensitivity of the processed difference to the change-in-state. The resulting AI process after training is the set of computer instructions and configuration information specific to the training set and is executed as part of the “automated change in state assessment” after the standard non-AI procedure. The result is a decision that can be combined with the non-AI decision or taken alone for the issuance of a “change-in-state” notification.

Any positive change-in-state is automatically logged as an auditable system record, along with all supporting information including characterization information, data or image snippets, or analysis metrics or results. Upon attainment of certain conditions and measures of confidence, a flag is set for a notifiable event, and the system then proceeds to automatically issue the notification including measures of confidence. The automated notification is issued to field operator personnel and automatically forwarded to any control systems of hardware components via computer-to-computer communications.

Modern facility operations involving industrial scale equipment rely on supervisory control and data acquisition systems (SCADA) and distributed control systems (DCS), or similar automated or semi-automated systems for monitoring and controlling and coordinating industrial scale processes of equipment. For geologic asset field operations that include a significant risk of induced seismicity or other geologic disruption, “adaptive traffic light systems (ATLS)” have been instituted to assist in managing and mitigating risks alongside SCADA and DCS controls. The ATLS is a site-specific, real-time, risk management system with several discrete response levels.

The general concept is that geologic asset monitoring is performed by acquisition of measurements sensitive to the state of the geologic asset including reservoirs and confining structures, and key parameters or indicators are derived from the measurements, which then become the inputs to the SCADA or DCS, and then into the ATLS (Braun et al. 2024). The ATLS provides a decision control framework for dealing with anomalies determined by comparison to expectations, model predictions, and/or regulation allowances. The ATLS consists of a decision workflow based on understanding of technical risks and determining the existing overall state of operations at any particular facility. The ATLS “decisions” are actions (e.g., a corrective action or mitigation action) taken on control of facility operating parameters such as pressure, injected/extracted volumes and rates, and run from prescribed reduction in pressure or volumes to suspension of operations, as well as prescribed conditions for return to normal operations. Such reactive ATLS risk management and mitigation systems are commonly used with near-real-time passive microseismic monitoring data acquisition and analysis systems such as described in U.S. Pat. No. 12,117,576 and Braun et al (2024).

However, more recently ATLS protocols have increasingly been applied to geothermal and hydrocarbon exploitations, wastewater injection, carbon capture and storage, natural gas and hydrogen storage, hydraulic fracturing, impoundment reservoirs, and mining. More recently, improved measurements including those derived from active source seismic surveys, see Kronimus et al., Criteria for decision making in site abandonment, CO2Care (2014), have allowed forward looking probabilistic decision frameworks, and assessing the geomechanical and seismicity expectations based on integration of key parameters, risk, and hazard knowledge made possible by seismic and other measurements of the geologic asset change in state (Braun et al., 2024).

Moreover, for some geologic asset management applications, it is a legal requirement to prove conformance (also called conformity) between reservoir models and observations. Conformance is largely measured using active source seismic surveys, and is quantified by differences between model predictions and monitoring data, called the model-monitoring offset (MMO). Traffic light decision support systems have been constructed around treatment of these offsets, using monitoring information such as the time-lapse imaging differences and derived information generated with the system described herein.

As illustrated in Error! Reference source not found., Error! Reference source not found., and Error! Reference source not found., the volumetric phased array systems act as the basic input for both the Automated Real Time Microseismic Processing System 214 which encompasses passive seismic monitoring functionality and the Seismic Survey Processing System 216 which encompass semi-automated or automated active source seismic survey analysis functionality. The results of both provide information reduced from seismic measurements and images of notifiable changes-in-state of the underground assets, and are managed in the system Change-in-state Notification Manager 218 (Notification Manager in short). Therefore, the Automated Real Time Microseismic Processing System 214 and the Seismic Survey Processing System 216 are designed to provide the informational inputs required for determining the overall time-lapse changes and model-monitoring offsets that feed an ATLS. A single Notification Manager handles the output from any number of Seismic Survey Processing System 216 instantiations and communication through defined reporting channels into facility control systems. The Notification Manager coordinates and packages available information as a computer-to-computer communication of actionable information, to be used within the facility SCADA or DCS systems, and with established ATLS or similar protocols to effect operating changes in the facility key industrial subsystems. The Seismic Survey Processing System 216 is in part designed to provide improved information inputs for control systems to enable a more advanced ATLS.

The Notification Manager 218 maintains the list of notifications and notification types, and all data that supports the notification of a detected change-in-state. Outside of the computer-to-computer communication of the Change-in-state notification, results from the Seismic Survey Processing System 216 are optionally communicated via standard Web Services to the designated computational resources under control of the facility operator for display via a graphical user interface. The user interface (UI) construction may be based on a client/server architecture, with web UI client typically written in HTML and Javascript which runs in standard browser software. The web client connects to the web server to download the information to display for the operator. Advantageously, the web server is hosted on whatever computational platform that hosts the database hardware and controlling software. For example, when the client system requests messages from the Web Services software for notification information, the information is displayed initially on a map. The UI client provides the ability to “drill-down” into the notification, through the “layers” of provided information, and comparison with any historical information.

Field control systems will include the ability to input information provided by one or more seismic monitoring systems, and then potentially react to that received information to effect a change in facility operations following established ATLS protocols or similar reactive protocol systems. Nominally, the operational change is based on understandings of risk derived from the measurements or analysis results, and constitutes instructions to maintain or reduce volumes or pressures using mechanical control systems. The instructions may be computer instructions or may be recommendations to operators that require operator affirmation to enact a set of computer instructions to mechanical control systems. The notification provided by the seismic monitoring system provides condition-based monitoring information such that pressure controls, fluid injection systems featuring pumps, downhole lift systems featuring downhole pumps, automated valve systems at the well head or in the injection control systems are then adjusted to limit or reduce flow, reduce pressures, shut down or related actions that reduce or mitigate risk to the geologic assets and infrastructure.

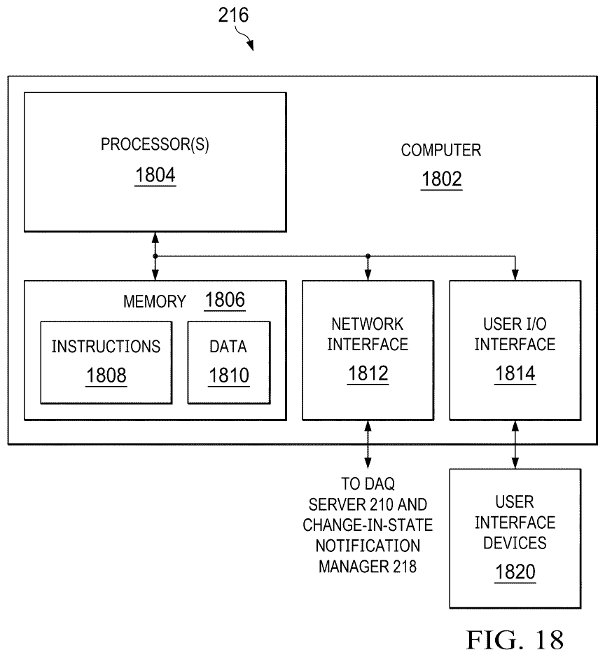

FIG. 18 is a block diagram of an example Seismic Survey Processing System 216 suitable for use in the seismic data acquisition and processing system 200. The Seismic Survey Processing System 216 includes a computer 1802 and user interface devices 1820. The computer 1802 may include, for example, a processor 1804 and memory 1806. The processor 1804 may include a single processor or multiple processors. Further, the processor 1804 may include different kinds of processors, such as a CPU, a GPU, and AI processing unit, etc. The memory 1806 may include a number of software or firmware modules executable by processor 1804. Memory 1806 is a non-transitory computer-readable medium and may include a single memory device or multiple memory devices, including volatile and/or non-volatile semiconductor memory, magnetic memory, optical memory, etc. The memory 1806 may store instructions 1808 for executing the operations described herein, for example the operations of the methods 1300, 1400, 1500, and/or 1600. The memory 1806 may also store data 1810, which may include seismic data provided by the DAQ Server 210, or any data described herein. Although components are depicted within a single computer 1802, the components and functionalities described with respect to the computer 1802 may instead be reconfigured in a different combination or may be distributed among multiple computing and storage devices in a rack system, for example.

The computer 1802 includes a network interface 1812, and a user I/O interface 1814 coupled to the processor 1804. The network interface 1812 may provide a wired or wireless interface to communicate with network devices. For example, the processor 1804 may be coupled to the DAQ Server 210 and the Change-in-State Notification Manager 218 via the network interface 1812. The computer 1802 may also be coupled to other computers, network devices, networks, etc., remote or local, via the network interface 1812.

The Seismic Survey Processing System 216 may also include user interface devices 1820, such as keyboards, monitors, etc.) that allow a user to interact with the Seismic Survey Processing System 216. The user interface devices 1820 may be coupled to the computer 1802 via the user I/O interface 1814. The computer 1802 may provide images of and/or information about geologic structures, and detected changes in geologic structures, on a display device, such as a computer monitor, to inform a user of the seismic data acquisition and processing system 200. The computer 1802, or systems communicatively coupled to the computer 1802, may automatically, or responsive to a control prompt received via a user interface device, initiate a change in utilization of the geologic structures based on the images and/or information provided by the computer 1802 as described herein.

While the invention has been described with reference to particular embodiments, it will be understood by those skilled in the art that various changes may be made, and equivalents may be substituted for elements thereof without departing from the scope of the invention. Accordingly, the scope of the invention is only limited by the claims which follow.

What is claimed is:

1. A system, comprising:
an active seismic source configured to provide controlled seismic energy;
a compact volumetric phased array configured to detect seismic signals generated responsive to the controlled seismic energy;
a processing system coupled to the compact volumetric phased array, the processing system configured to:
generate, at a first time, a first image representative of a geologic structure based on the seismic signals produced by a first activation of the active seismic source;
generate, at a second time, a second image representative of the geologic structure based on the seismic signals produced by a second activation of the active seismic source; and
responsive to generation of the first and second images, automatically determine a difference between the first image and the second image; and provide a change-in-state notification based on the difference.

2. The system of claim 1, further comprising multiple compact volumetric phased arrays configured to detect seismic signals and provide the detected seismic signals to the processing system for use in generating images of the geologic structure for multiple acquisition geometries.

3. The system of claim 1, wherein the processing system includes a database configured to store processed seismic signals, the first and second images, processing system parameters and configuration information, image difference information, and the change-in-state notification.

4. The system of claim 1, further comprising a user interface coupled to the processing system, wherein the user interface is configured to receive the change-in-state notification and initiate a corrective action with respect to facility operations and the geologic structure.

5. The system of claim 4, wherein the user interface is configured to display the difference between the first image and the second image and information derived from the differences, and analyze the change-in-state notification.

6. The system of claim 1, wherein the processing system is configured to provide the change-in-state notification to an external operations management system configured to initiate corrective actions directed to the geologic structure.

7. The system of claim 6, wherein the external operations management system is an operations management traffic light system for alerting an operator, and for automatically initiating and controlling the corrective actions.

8. The system of claim 1, wherein the processing system is configured to automatically generate the second image, determine the difference between the first image and the second image, and provide the change-in-state notification responsive to acquisition of the seismic signals produced by the second activation of the active seismic source.

9. The system of claim 1, wherein the processing system is configured to operate at a site remote from the compact volumetric phased array.

10. The system of claim 1, wherein the processing system is configured to:
generate a supergather in which collected signals from the compact volumetric phased array are summed and processed; and
apply automated beamforming to a target depth point to provide a receiver gather image representing the geologic structure within a selected offset range.

11. A method, comprising:
acquiring first seismic signals using one or more compact volumetric phased arrays, and providing the first seismic signals to a processing system;
processing, by the processing system, the first seismic signals to produce a first image representative of a geologic structure;
acquiring second seismic signals using the one or more compact volumetric phased arrays, and providing the second seismic signals to the processing system;
processing, by the processing system, the second seismic signals to produce a second image representative of the geologic structure;
automatically generating time-lapse change-in-state information representing a difference between the first image and the second image; and
automatically providing a change-in-state notification indicating a need for corrective action directed to the geologic structure.

12. The method of claim 11, further comprising: automatically applying, by the processing system, grid regularization or normalization to the seismic signals.

13. The method of claim 11, further comprising: automatically applying, by the processing system, equalization of detected signal strength among like channels in an array.

14. The method of claim 11, further comprising: generating, by the processing system, a volumetric phased array supergather, in which collected signals are processed to generate an enhanced receiver gather image.

15. The method of claim 11, further comprising: applying, by the processing system, automated beamforming to a target depth point to provide an enhanced receiver gather image representing the geologic structure within a selected offset range.

16. The method of claim 11, further comprising: automatically processing, storing, and displaying, by the processing system, images of the geologic structure generated at multiple subsequent points in time to enable time-lapse differencing of the images, deriving time-lapse information to determine a change-in-state of the geologic structure.

17. The method of claim 11, further comprising using a permanently emplaced seismic source to generate the first seismic signals and the second seismic signals received by the one or more compact volumetric phased arrays.

18. The method of claim 17, further comprising automatically processing the first and second seismic signals and generating the change-in-state notification in near real-time.

19. The method of claim 11, further comprising: utilizing, by the processing system, artificial intelligence or machine learning processes for automatically identifying time-lapse anomalies in difference images and extracting information from the difference images.

20. The method of claim 11, further comprising: automatically generating, by the processing system, the change-in-state notification based on the time-lapse change-in-state information indicating change surpassing a threshold.

21. The method of claim 11, further comprising: providing, by the processing system, the change-in-state notification to an automated control system for automatically initiating mitigation action directed to the geologic structure.

22. A seismic system comprising:
an active seismic source configured to provide controlled seismic energy;
a compact volumetric phased array configured to detect seismic signals generated responsive to the controlled seismic energy; and
a data acquisition system coupled to the active seismic source and the compact volumetric phased array, the data acquisition system configured to record the seismic signals detected by the compact volumetric array.
